(19) United States
(12) Patent Application Publication
(10) Pub. No.: US 2026/0194213 A1
(43) Pub. Date: Jul. 9, 2026

(54) LIGHTING DEVICE

(71) Applicant: Japan Display Inc., Tokyo (JP)

(72) Inventors: Tae KUROKAWA, Tokyo (JP); Takeo KOITO, Tokyo (JP)

(21) Appl. No.: 19/560,966

(22) Filed: Mar. 9, 2026

Related U.S. Application Data
(63) Continuation of application No. PCT/JP2024/031849, filed on Sep. 5, 2024.

(30) Foreign Application Priority Data
Sep. 26, 2023 (JP) 2023-163201

(51) Int. Cl. F21V 14/00; G02F 1/1335

(52) U.S. Cl. CPC F21V 14/003; G02F 1/133528

(57) ABSTRACT

A lighting device includes a light source configured to illuminate a target space, and a light shielding element disposed on an optical path of light emitted from the light source. The light shielding element includes a first liquid crystal panel including a first substrate, a second substrate facing the first substrate, and a first liquid crystal layer disposed between the first substrate and the second substrate. The light shielding element includes a first/second polarizing plate sandwiching the first liquid crystal panel and arranged in a crossed or parallel-Nicols configuration. The first liquid crystal panel has a first common electrode and a plurality of first drive electrodes. The light shielding element is configured such that each of the plurality of first drive electrodes is independently controlled to switch between a light-shielding mode that blocks light from the light source and a transmission mode that transmits light from the light source.

### CROSS-REFERENCE TO RELATED APPLICATIONS

This application is a Continuation of International Patent Application No. PCT/JP2024/031849, filed on September 5, 2024, which claims the benefit of priority to Japanese Patent Application No. 2023-163201, filed on September 26, 2023, the entire contents of which are incorporated herein by reference.

### FIELD

An embodiment of the present invention relates to a lighting device capable of controlling an illumination range of light by utilizing an electro-optical effect of a liquid crystal.

### BACKGROUND

As a lighting device utilizing an electro-optical effect of a liquid crystal, a lighting device is disclosed that is capable of adjusting an amount of emitted light for each irradiation direction of light by using a liquid crystal cell arranged to cover a light source (refer to Japanese laid-open patent publication No. 2018-073661). In addition, a lighting device is disclosed that forms a plurality of periodic spot patterns that do not overlap on a projection surface by passing light emitted from a light source through a liquid crystal cell (refer to Japanese laid-open patent publication No. 2013-505472).

A lighting fixture that emits spotlight and is installed indoors is capable of adjusting brightness with a dimming function; however, such a fixture has a structure in which an irradiation position cannot be freely changed because a position of a light source is fixed. Furthermore, in railway vehicles, aircraft, or the like, there are instances where reading lights attached to flexible tubes are installed at individual passenger seats, however, in order to change an irradiation position, a user needs to manually bend the flexible tube.

### SUMMARY

A lighting device according to an embodiment of the present invention includes a light source configured to illuminate a target space, and a light shielding element disposed on an optical path of light emitted from the light source. The light shielding element includes a first liquid crystal panel including a first substrate, a second substrate facing the first substrate, and a first liquid crystal layer disposed between the first substrate and the second substrate. The light shielding element further includes a first polarizing plate and a second polarizing plate sandwiching the first liquid crystal panel and arranged in a crossed-Nicols configuration or a parallel-Nicols configuration. The first liquid crystal panel has a first common electrode and a plurality of first drive electrodes. The light shielding element is configured such that each of the plurality of first drive electrodes is independently controlled to switch between a light-shielding mode that blocks light from the light source and a transmission mode that transmits light from the light source.

### BRIEF DESCRIPTION OF DRAWINGS

FIG. 1A is a view illustrating a configuration of a lighting device according to an embodiment of the present invention.

FIG. 1B is a view illustrating a configuration of a lighting device according to an embodiment of the present invention.

FIG. 1C is a view illustrating a configuration of a lighting device according to an embodiment of the present invention.

FIG. 1D is a view illustrating a configuration of a lighting device according to an embodiment of the present invention.

FIG. 2A is an exploded view illustrating a configuration of a light shielding element used in a lighting device according to an embodiment of the present invention.

FIG. 2B is an exploded view illustrating a configuration of a light shielding element used in a lighting device according to an embodiment of the present invention.

FIG. 2C is an exploded view illustrating a configuration of a light shielding element used in a lighting device according to an embodiment of the present invention.

FIG. 2D is an exploded view illustrating a configuration of a light shielding element used in a lighting device according to an embodiment of the present invention.

FIG. 3 is a cross-sectional view illustrating a configuration of a light shielding element used in a lighting device according to an embodiment of the present invention.

FIG. 4A is a view illustrating a configuration of a lighting device according to an embodiment of the present invention.

FIG. 4B is a view illustrating an irradiation pattern of irradiation light irradiated by a lighting device according to an embodiment of the present invention.

FIG. 5 is a perspective view illustrating a configuration of a liquid crystal light control element used in a lighting device according to an embodiment of the present invention.

FIG. 6A is a cross-sectional view illustrating an operation of a liquid crystal light control element used in a lighting device according to an embodiment of the present invention.

FIG. 6B is a cross-sectional view illustrating an operation of a liquid crystal light control element used in a lighting device according to an embodiment of the present invention.

FIG. 7A is an exploded view illustrating a configuration of a lighting device according to an embodiment of the present invention.

FIG. 7B is an exploded view illustrating a configuration of a lighting device according to an embodiment of the present invention.

FIG. 8A is an exploded view illustrating a configuration of a lighting device according to an embodiment of the present invention.

FIG. 8B is an exploded view illustrating a configuration of a lighting device according to an embodiment of the present invention.

FIG. 9A is an exploded view illustrating a configuration of a lighting device according to an embodiment of the present invention.

FIG. 9B is an exploded view illustrating a configuration of a lighting device according to an embodiment of the present invention.

FIG. 10A is an exploded view illustrating a configuration of a lighting device according to an embodiment of the present invention.

FIG. 10B is an exploded view illustrating a configuration of a lighting device according to an embodiment of the present invention.

FIG. 11A is a plan view illustrating a configuration of a drive electrode of a light shielding element used in a lighting device according to an embodiment of the present invention.

FIG. 11B is a cross-sectional view illustrating a configuration of a light shielding element used in a lighting device according to an embodiment of the present invention.

FIG. 11C is a diagram illustrating waveforms of drive signals for driving a light shielding element used in a lighting device according to an embodiment of the present invention.

FIG. 11D is a diagram illustrating waveforms of drive signals for driving a light shielding element used in a lighting device according to an embodiment of the present invention.

FIG. 12 is a cross-sectional view illustrating a configuration of a light shielding element used in a lighting device according to an embodiment of the present invention.

FIG. 13 is a plan view illustrating a configuration of a drive electrode of a light shielding element used in a lighting device according to an embodiment of the present invention.

FIG. 14 is a plan view illustrating a configuration of a drive electrode of a light shielding element used in a lighting device according to an embodiment of the present invention.

FIG. 15 is a view illustrating a configuration of a drive electrode of a light shielding element used in a lighting device according to an embodiment of the present invention.

FIG. 16 is a view illustrating a configuration of a drive electrode of a light shielding element used in a lighting device according to an embodiment of the present invention.

FIG. 17 is a plan view illustrating a configuration of a light shielding element used in a lighting device according to an embodiment of the present invention.

FIG. 18A is a plan view illustrating an arrangement of drive electrodes of a light shielding element used in a lighting device according to an embodiment of the present invention.

FIG. 18B is a plan view illustrating an arrangement of drive electrodes of a light shielding element used in a lighting device according to an embodiment of the present invention.

FIG. 18C is a plan view illustrating an arrangement of drive electrodes of a light shielding element used in a lighting device according to an embodiment of the present invention.

FIG. 18D is a plan view illustrating an arrangement of drive electrodes of a light shielding element used in a lighting device according to an embodiment of the present invention.

### DESCRIPTION OF EMBODIMENTS

Hereinafter, embodiments of the present invention will be described with reference to the drawings and the like. However, the present invention can be implemented in many different modes and should not be construed as being limited to the description of the embodiments exemplified below. For the purpose of clarity, the drawings may schematically illustrate widths, thicknesses, shapes, and the like of respective parts compared with actual modes, however, these are merely examples and do not limit the interpretation of the present invention. Furthermore, in the present specification and each drawing, elements similar to those described above with reference to the previous drawings are denoted by the same reference numerals (or numerals followed by letters such as A, B, or the like), and detailed descriptions thereof may be omitted as appropriate. In addition, notations such as “first” and “second” added to each element are convenient labels used to distinguish the elements and have no further meaning unless otherwise specified.

In the present specification, when a certain member or region is described as being “on (or under)” another member or region, unless otherwise specifically limited, this includes not only a case where the member or region is directly on (or directly under) the other member or region but also a case where the member or region is above (or below) the other member or region, that is, a case where another component is included between them above (or below) the other member or region.

In the present specification, “light distribution” refers to, in accordance with its ordinary meaning, a degree of spreading of light emitted from a light source, that is, a luminous intensity (light intensity) distribution for each direction. Furthermore, “controlling the light distribution” refers to intentionally controlling the degree of spreading of the light emitted from the light source.

In the present specification, “optical rotation” refers to a phenomenon in which a polarization axis of a linearly polarized light component is rotated when the linearly polarized light component passes through a liquid crystal layer.

In the present specification, an “alignment direction” of an alignment film refers to a direction in which liquid crystal molecules are aligned when a treatment for imparting an alignment regulating force (for example, a rubbing treatment) is performed on the alignment film to align the liquid crystal molecules on the alignment film. When the treatment performed on the alignment film is a rubbing treatment, the alignment direction of the alignment film is generally a rubbing direction.

In the present specification, an “extending direction” of a strip-shaped electrode refers to a direction in which a long side of a pattern having a short side (width) and a long side (length) extends when the strip-shaped electrode is viewed in a plan view.

### FIRST EMBODIMENT

A lighting device according to an embodiment of the present invention has a function of irradiating light emitted from a light source as a spotlight to a specific region, and further has a function of moving an irradiation position of the spotlight.

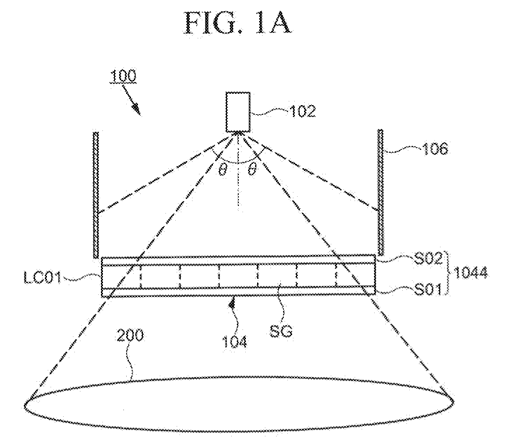

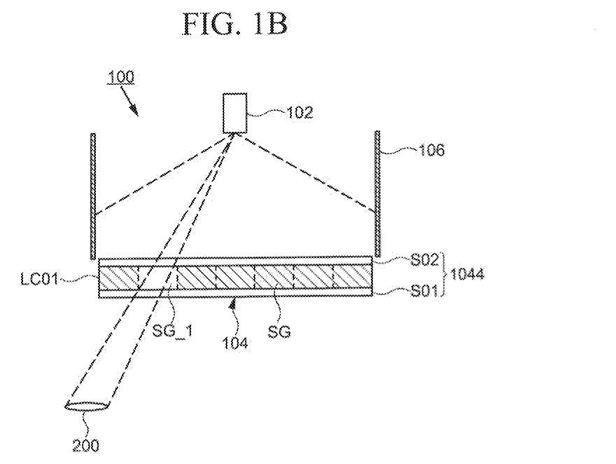

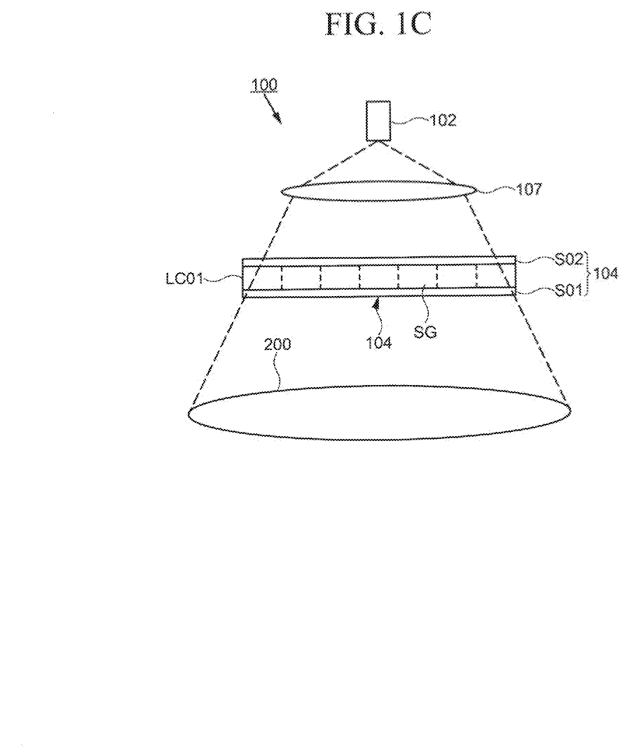

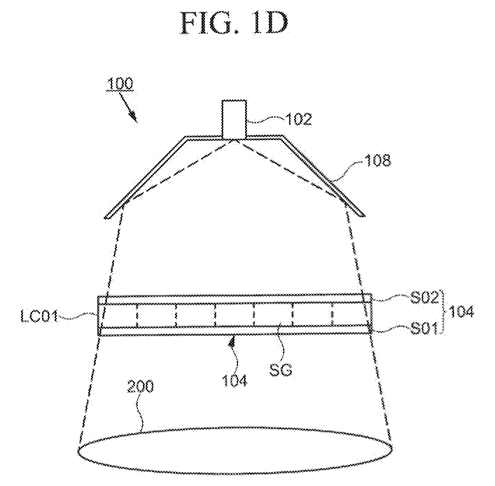

FIG. 1A is a view illustrating a configuration of a lighting device 100 according to an embodiment of the present invention. The lighting device 100 according to the present embodiment includes a light source 102 configured to illuminate a target space and a light shielding element 104 capable of partially shielding light emitted from the light source 102. Note that the target space is a space to which illumination is provided, and includes various spaces such as a space related to human living and production activities in a house, an office, a factory, or the like, a space in a cabin of an automobile, a railway vehicle, a vessel, an aircraft, or the like, and a plant cultivation space in a plant factory.

In the present embodiment, the light source 102 is preferably a point light source configured to emit light radially, or a light source that can be substantially regarded as a point light source. The light source 102 is, for example, a light-emitting diode (LED) light source. Further, a halogen lamp, a xenon lamp, or the like may be used as the light source 102.

The light shielding element 104 is an element utilizing an electro-optical effect of a liquid crystal. The light shielding element 104 has a function of electrically controlling switching between a transmission mode and a light-shielding mode. As shown in FIG. 1A, the light shielding element 104 is disposed between the light source 102 and an irradiation surface 200 on which light emitted from the light source 102 is irradiated. In other words, the light shielding element 104 is disposed on an optical path of the emitted light to block the light emitted from the light source 102.

The light shielding element 104 includes a liquid crystal panel 1044. The liquid crystal panel 1044 includes a first substrate S01, a second substrate S02 facing the first substrate S01, and a liquid crystal layer LC01 disposed between the first substrate S01 and the second substrate S02. The liquid crystal panel 1044 is divided into a plurality of regions SG, and is configured such that a light-shielding state and a transmission state can be controlled for each of the plurality of regions SG. In other words, the light shielding element 104 has the plurality of regions SG and is configured to be capable of switching between a light-shielding mode that blocks light and a transmission mode that transmits light for each of the plurality of regions SG.

The transmission mode is a state in which light emitted from the light source 102 is transmitted, and the light-shielding mode is a state in which the light emitted from the light source 102 is blocked. Although not shown in detail in FIG. 1A, the liquid crystal panel 1044 is provided with a common electrode and a plurality of drive electrodes, and the drive electrodes allow for control between the light-shielding mode and the transmission mode for each of the regions SG. Further, although omitted in FIG. 1A, the light shielding element 104 is configured to be capable of switching between the transmission mode and the light-shielding mode through a combination of the liquid crystal panel 1044 and optical components (such as polarizing plates) not shown in the figure.

FIG. 1A schematically illustrates a state in which all the regions SG of the light shielding element 104 are controlled to the transmission mode. On the other hand, FIG. 1B illustrates a state in which a specific region SG_1 is set to the transmission mode, and the other regions SG are set to the light-shielding mode. In this state, light that has passed through the region SG_1 controlled to the transmission mode is irradiated onto the irradiation surface 200, whereas light is not transmitted through the regions SG controlled to the light-shielding mode. As is clear from comparison with FIG. 1A, in the state illustrated in FIG. 1B, the light emitted from the light source 102 is irradiated onto the irradiation surface 200 as a spotlight.

The light shielding element 104 has the plurality of regions SG, and each region SG can optionally set a transmission mode and a light-shielding mode. Therefore, the irradiation position of the spotlight can be changed by changing the position of the region SG_1 in the transmission mode. Note that while FIG. 1B illustrates an example in which one region SG_1 among the plurality of regions SG is controlled to the transmission mode, the present embodiment is not limited to this example, and some of the regions SG may be collectively controlled to the transmission mode.

Note that the region SG may be, as described later, a region defined by the common electrode provided in the liquid crystal panel and a single drive electrode facing the common electrode, or may be a region defined by a set of a plurality of mutually adjacent drive electrodes.

As shown in FIG. 1A, when, for example, an LED light source is used as the light source 102, a light distribution angle θ of the emitted light is approximately ±60 degrees. As shown in FIG. 1A, a shielding plate 106 may be added to the lighting device 100 so that light emitted from the light source 102 does not leak to the outside without being shielded by the light shielding element 104. Although there is no limitation on the shape of the shielding plate 106, the shielding plate 106 preferably has a shape surrounding a space between the light source 102 and the light shielding element 104.

As shown in FIG. 1C, an optical system 107 may be provided between the light source 102 and the light shielding element 104 in the lighting device 100 in order to impart directivity to the light emitted from the light source 102. The optical system 107 may be composed of at least one lens. By using the optical system 107, a light distribution angle of the light emitted from the light source 102 can be adjusted, and the emitted light can be prevented from diffusing to the outside of the light shielding element 104. Further, as shown in FIG. 1D, a reflector 108 may be disposed around the light source 102. It is possible to control the light distribution of the light emitted from the light source 102 by disposing the reflector 108. The configuration of the optical system 107 shown in FIG. 1C and the configuration of the reflector 108 shown in FIG. 1D may be combined with the shielding plate 106 shown in FIG. 1A.

The lighting device 100 according to the present embodiment has a configuration in which the light source 102 and the light shielding element 104 are combined. The light shielding element 104 can restrict an irradiation area of the light emitted from the light source 102 to a specific area and can irradiate the spotlight. Since the light shielding element 104 can arbitrarily control regions to be set to the light-shielding mode and regions to be set to the transmission mode and can perform such control dynamically, the irradiation position of the spotlight can be moved freely.

Note that the size (area in a plan view) of the light shielding element 104 can be appropriately provided ranging from a small area to a large area, similar to a liquid crystal display. Accordingly, the lighting device 100 can be provided in various sizes such that a range in which the spotlight can be moved varies from a narrow range to a wide range.

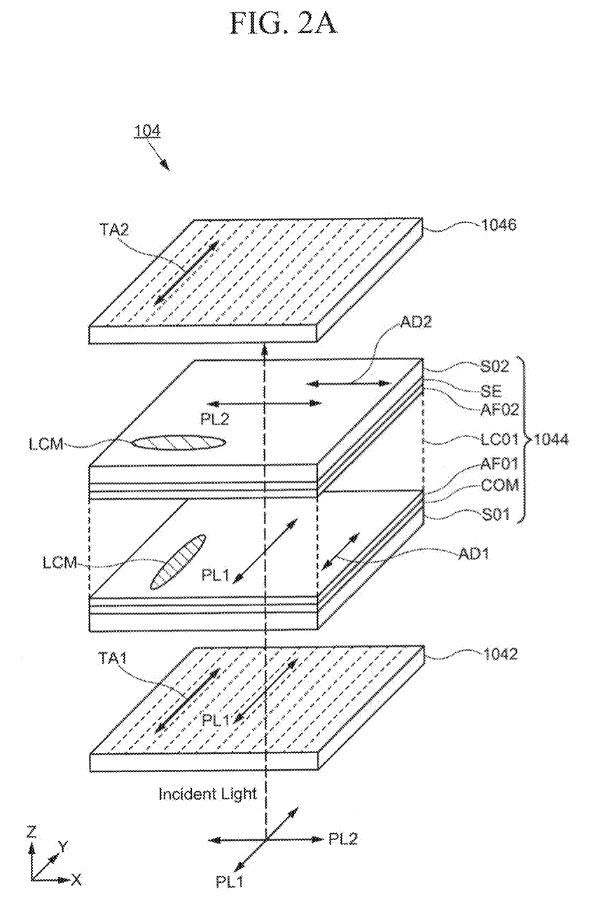

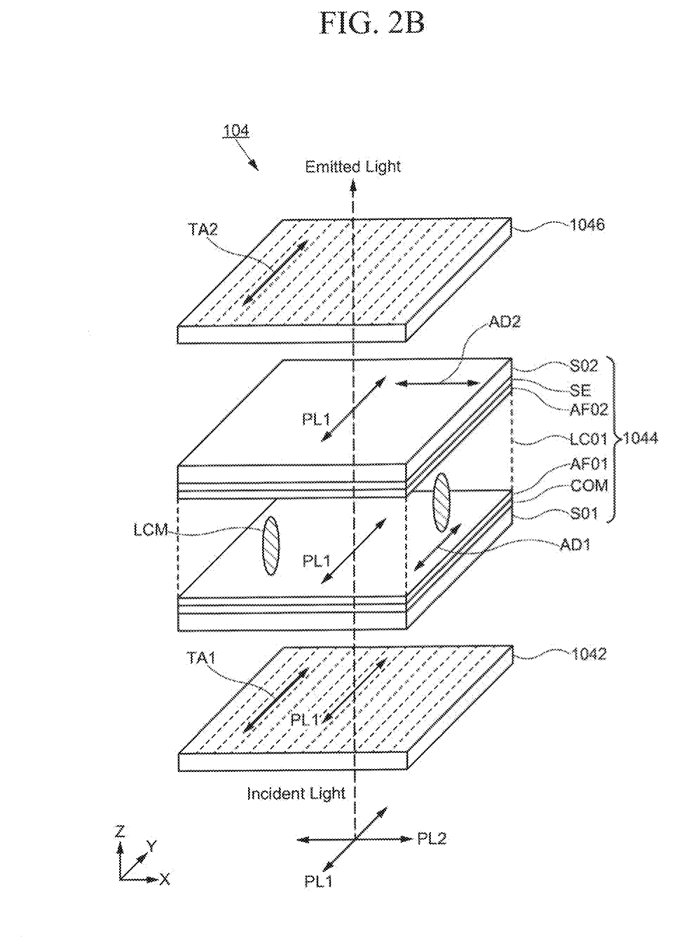

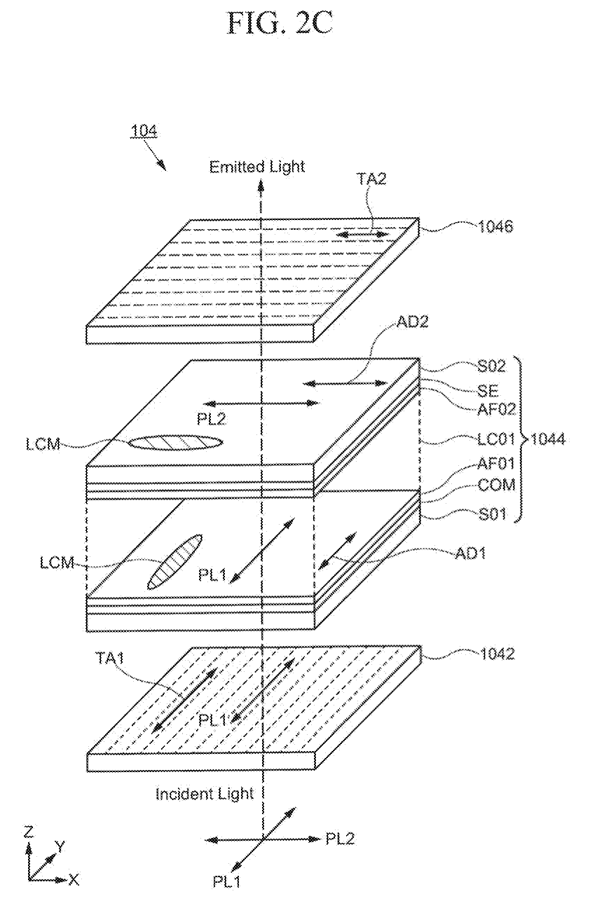

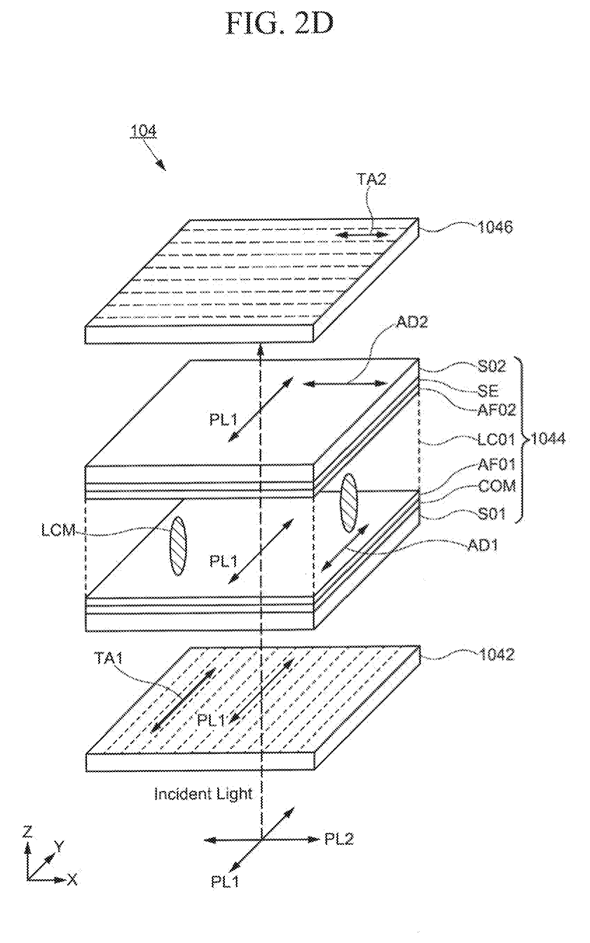

Next, the operation of the light shielding element 104 will be described with reference to FIG. 2A and FIG. 2B. FIG. 2A and FIG. 2B are exploded views of the light shielding element 104, illustrating a configuration of one region controllable to the light-shielding mode and the transmission mode.

Note that in FIG. 2A and FIG. 2B, X, Y, and Z-axis directions are shown for the sake of explanation. The X-axis direction and the Y-axis direction are orthogonal to each other in a plan view, and the Z-axis direction extends in a normal direction to an X-Y plane. In the following description, expressions such as “X-axis direction,” “Y-axis direction,” and “Z-axis direction” are used to identify directions, however, these expressions can be replaced with expressions such as “first direction” for the X-axis direction, “second direction” for the Y-axis direction, and “third direction” or “vertical direction” for the Z-axis direction. Such directions of the X, Y, and Z-axes are the same even when referring to other drawings unless otherwise specified.

The light shielding element 104 includes the liquid crystal panel 1044, a first polarizing plate 1042, and a second polarizing plate 1046. The liquid crystal panel 1044 includes a common electrode COM, the first substrate S01 provided with a first alignment film AF01, the second substrate S02 provided with a drive electrode SE and a second alignment film AF02, and the liquid crystal layer LC01 disposed between the first substrate S01 and the second substrate S02. The first alignment film AF01 is provided so as to cover the common electrode COM, and the second alignment film AF02 is provided so as to cover the drive electrode SE. Alignment directions of the first alignment film AF01 and the second alignment film AF02 are defined by an alignment treatment such as rubbing. In the examples shown in FIG. 2A and FIG. 2B, an alignment direction AD1 of the first alignment film AF01 is oriented in the Y-axis direction, and an alignment direction AD2 of the second alignment film AF02 is oriented in the X-axis direction. That is, the alignment direction AD1 and the alignment direction AD2 have an intersecting relationship (being orthogonal to each other).

The liquid crystal panel 1044 is a transmissive panel. The common electrode COM and the drive electrode SE are formed of a transparent conductive film. A metal auxiliary wiring may be added to the transparent conductive film so as to reduce sheet resistance. Alternatively, the common electrode COM and the drive electrode SE may be formed of a light-transmitting mesh-like metal film.

The liquid crystal layer LC01 is formed of, for example, a twisted nematic (TN) liquid crystal. FIG. 2A and FIG. 2B schematically illustrate liquid crystal molecules LCM of the liquid crystal layer LC01. The liquid crystal molecules LCM have an elongated rod-like molecular structure. An initial alignment state of the liquid crystal molecules LCM is regulated by the alignment direction AD1 of the first alignment film AF01 on the first substrate S01 side and by the alignment direction AD2 of the second alignment film AF02 on the second substrate S02 side. That is, the liquid crystal molecules LCM on the first substrate S01 side are aligned with a long axis direction thereof in the same direction as the alignment direction AD1 of the first alignment film AF01, and the liquid crystal molecules LCM on the second substrate side are aligned with a long axis direction thereof in the same direction as the alignment direction AD2 of the second alignment film AF02. The liquid crystal molecules LCM in the liquid crystal layer LC01 are aligned in a state twisted by 90 degrees from the first substrate S01 to the second substrate S02 due to such an alignment regulating force.

The first polarizing plate 1042 is disposed on the first substrate S01 side, and the second polarizing plate 1046 is disposed on the second substrate S02 side. The first polarizing plate 1042 and the second polarizing plate 1046 are absorption-type linear polarizing plates. A linear polarizing plate has a characteristic of transmitting a polarization component parallel to a transmission polarization axis and absorbing (not transmitting) other polarization components. The transmission polarization axis TA1 of the first polarizing plate 1042 is disposed so as to be parallel to the alignment direction AD1 of the first alignment film AF01, and the transmission polarization axis TA2 of the second polarizing plate 1046 is disposed so as to intersect (be orthogonal to) the alignment direction AD2 of the second alignment film AF02. In other words, the transmission polarization axis TA1 of the first polarizing plate 1042 and the transmission polarization axis TA2 of the second polarizing plate 1046 are disposed in parallel (parallel Nicols).

FIG. 2A illustrates a case in which light having a first polarizing component PL1 and a second polarizing component PL2 emitted from the light source 102 (not shown) enters from the first polarizing plate 1042 side. Here, it is assumed that the polarization direction of the first polarizing component PL1 is parallel to the Y-axis direction, and the polarization direction of the second polarizing component PL2 is parallel to the X-axis direction. When light having such polarizing components enters the first polarizing plate 1042, the first polarizing component PL1 parallel to the transmission polarization axis TA1 is transmitted, and the second polarizing component PL2 is absorbed. Therefore, regarding the light emitted from the light source 102 (not shown), only the first polarizing component PL1 selectively passes through the first polarizing plate 1042 to enter the liquid crystal panel 1044.

FIG. 2A illustrates an OFF state in which no voltage is applied between the common electrode COM and the drive electrode SE. In a process of the first polarizing component PL1 passing through the liquid crystal layer LC01 from the first substrate S01 side to the second substrate S02 side, a polarization axis is rotated by 90 degrees and transitions to the second polarizing component PL2 because the liquid crystal molecules LCM are aligned with a 90-degree twist. The transmission polarization axis TA2 of the second polarizing plate 1046 has a relationship of intersecting the polarization axis of the second polarizing component PL2. Therefore, the second polarizing component PL2 emitted from the liquid crystal panel 1044 is absorbed by the second polarizing plate 1046. That is, in the OFF state in which no voltage is applied to the common electrode COM and the drive electrode SE of the liquid crystal panel 1044, light emitted from the light source 102 (not shown) is blocked by the light shielding element 104, resulting in a state in which the light is not emitted to the outside.

On the other hand, FIG. 2B illustrates an ON state in which a voltage is applied between the common electrode COM and the drive electrode SE. In the ON state, due to an effect of an electric field generated between the common electrode COM and the drive electrode SE, the long axis direction of the liquid crystal molecules LCM is aligned in a direction parallel to the electric field. That is, in the ON state, the liquid crystal molecules LCM are aligned in a state in which the long axis direction thereof rises vertically between the first substrate S01 and the second substrate S02. Accordingly, since the state in which the liquid crystal molecules LCM are twisted by 90 degrees is eliminated, the first polarizing component PL1 that has entered the liquid crystal panel 1044 from the first polarizing plate 1042 passes through the liquid crystal layer LC01 without being rotated and passes therethrough as the first polarizing component PL1.

The direction of the polarization axis of the first polarizing component PL1 that has passed through the liquid crystal panel 1044 is parallel to the transmission polarization axis TA2 of the second polarizing plate 1046. Accordingly, in the ON state in which a voltage is applied to the common electrode COM and the drive electrode SE of the liquid crystal panel 1044, light emitted from the light source 102 (not shown) passes through the light shielding element 104, resulting in a state in which the light is emitted to the outside.

As described with reference to FIG. 2A and FIG. 2B, the light-shielding mode that blocks incident light and the transmission mode that transmits the incident light can be controlled depending on a state of voltage application to the liquid crystal panel 1044. That is, the light shielding element 104 can appropriately switch between the light-shielding mode and the transmission mode depending on the presence or absence of a driving voltage. Note that while FIG. 2A and FIG. 2B illustrate the relationship between the common electrode COM and one drive electrode SE, it is possible to freely change a region in which light emitted from the light source 102 is transmitted and a range in which the light is transmitted by arranging a plurality of drive electrodes SE with respect to the common electrode COM.

FIG. 2C and FIG. 2D illustrate an example of the light shielding element 104 in which, relative to the light shielding element 104 shown in FIG. 2A and FIG. 2B, the transmission polarization axis TA2 of the second polarizing plate 1046 is disposed parallel to the X-axis direction. That is, the light shielding element 104 is shown in which the transmission polarization axis TA1 of the first polarizing plate 1042 and the transmission polarization axis TA2 of the second polarizing plate 1046 are disposed orthogonally (crossed Nicols) to each other.

FIG. 2C illustrates the OFF state in which no voltage is applied between the common electrode COM and the drive electrode SE. In this state, since the polarization direction of the second polarizing component PL2 emitted from the liquid crystal panel 1044 is parallel to the transmission polarization axis TA2 of the second polarizing plate 1046, light emitted from the light source 102 (not shown) passes through the second polarizing plate 1046, resulting in a state in which the light is emitted to the outside. On the other hand, FIG. 2D illustrates the ON state in which a voltage is applied between the common electrode COM and the drive electrode SE. In this state, since the polarization direction of the first polarizing component PL1 emitted from the liquid crystal panel 1044 is orthogonal to the transmission polarization axis TA2 of the second polarizing plate 1046, the light emitted from the light source 102 (not shown) does not pass through the second polarizing plate 1046, resulting in a state in which the light is not emitted to the outside.

As described above, the light shielding element 104 according to the present embodiment can control the light-shielding mode and the transmission mode in either of the cases in which a pair of polarizing plates (the first polarizing plate 1042 and the second polarizing plate 1046) is arranged in parallel Nicols or in crossed Nicols.

Note that while FIG. 2A to FIG. 2D illustrates two states of the liquid crystal panel 1044, which are the light-shielding mode and the transmission mode, it is also possible to perform control to a semi-transmission mode in which the alignment of the liquid crystal molecules LCM is in an intermediate state.

Note that while FIG. 2A to FIG. 2D illustrate a configuration in which one drive electrode SE is disposed for the common electrode COM, the light shielding element 104 can arrange a plurality of drive electrodes SE with respect to the common electrode COM to individually control a voltage application state. With such a configuration, the irradiation position of the spotlight can be changed. Furthermore, by sequentially switching the drive electrodes SE to be set to the transmission mode, it is possible to produce an effect such that the spotlight appears to move continuously.

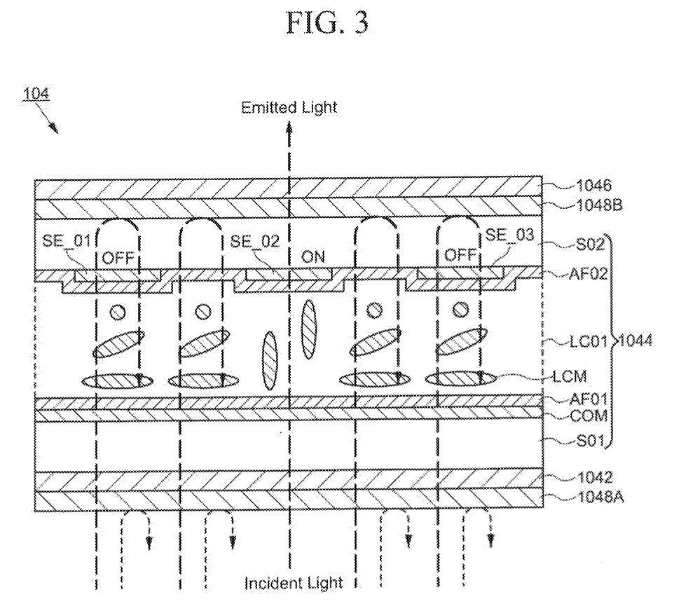

FIG. 3 illustrates a cross-sectional view of the light shielding element 104. The light shielding element 104 has a structure in which a first drive electrode SE_01, a second drive electrode SE_02, and a third drive electrode SE_03 are disposed facing the common electrode COM.

The first drive electrode SE_01, the second drive electrode SE_02, and the third drive electrode SE_03 are individually controlled to be in an ON state (a state in which a voltage is applied) or an OFF state (a state in which no voltage is applied). FIG. 3 illustrates a case in which the first drive electrode SE_01 and the third drive electrode SE_03 are in the OFF state and the second drive electrode SE_02 is in the ON state. Regions corresponding to the first drive electrode SE_01 and the third drive electrode SE_03 are formed as light-shielding mode regions in which light emitted from the light source 102 (not shown) is not transmitted. A region corresponding to the second drive electrode SE_02 is a transmission mode region in which the light emitted from the light source 102 (not shown) is transmitted.

Note that as shown in FIG. 3, the first drive electrode SE_01, the second drive electrode SE_02, and the third drive electrode SE_03 are disposed apart from each other. A liquid crystal is present also in a region between the first drive electrode SE_01 and the second drive electrode SE_02 and a region between the second drive electrode SE_02 and the third drive electrode SE_03. The liquid crystal in these inter-electrode regions is in the initial alignment state due to the alignment regulating force of the first alignment film AF01 and the second alignment film AF02. Since an electric field generated by the drive electrodes SE (SE_01 to SE_03) hardly acts on the inter-electrode regions, the alignment state of the liquid crystal molecules LCM is maintained in the initial alignment state. Accordingly, the inter-electrode regions of the drive electrodes SE (SE_01 to SE_03) are in the light-shielding mode, and a state in which light is not transmitted is maintained.

In the first polarizing plate 1042, a polarization component that is not parallel to the transmission polarization axis (the second polarizing component PL2) is absorbed by the first polarizing plate 1042. Since the lighting device 100 is irradiated with intense light from the light source 102, if the first polarizing plate 1042 absorbs the light emitted from the light source 102, there is a concern about degradation of the polarizing plate due to heat generation. To address such a problem, the light shielding element 104 shown in FIG. 3 has a structure in which a first brightness enhancement film 1048A is provided on a surface of the first polarizing plate 1042 opposite to the first substrate S01 side (i.e., the light incident side surface). The first brightness enhancement film 1048A has a characteristic of transmitting a specific polarization component and reflecting other polarization components. That is, the first brightness enhancement film 1048A has a characteristic of transmitting the first polarizing component PL1 and reflecting the second polarizing component PL2. It is possible to suppress light absorption at the first polarizing plate 1042 by aligning the transmission axis of the first brightness enhancement film 1048A with the transmission polarization axis of the first polarizing plate 1042.

Similarly, a second brightness enhancement film 1048B may be provided between the second substrate S02 and the second polarizing plate 1046. A polarization component that has passed through the first polarizing plate 1042, has been rotated by 90 degrees in the liquid crystal layer LC01, and has transitioned to the second polarizing component PL2, intersects with the transmission polarization axis of the second polarizing plate 1046, and thus is absorbed by the second polarizing plate 1046 and causes heat generation. Therefore, by providing the second brightness enhancement film 1048B and disposing a transmission axis thereof so as to coincide with the transmission polarization axis of the second polarizing plate 1046, the second polarizing component PL2 is reflected, and light absorption of the second polarizing plate 1046 can be suppressed.

As described with reference to FIG. 1B, under conditions in which the light shielding element 104 blocks light emitted from the light source 102 so that a spotlight is irradiated onto a specific region, most of the regions become light-blocking regions. Under such conditions, heat generation of the first polarizing plate 1042 and the second polarizing plate 1046 becomes a problem, however, as shown in FIG. 3, by providing the first brightness enhancement film 1048A and the second brightness enhancement film 1048B, polarization components that would otherwise be absorbed by the polarizing plates can be reflected, and the heat generation can be suppressed.

The lighting device 100 according to the present embodiment arranges the light shielding element 104 using a liquid crystal so as to block light emitted from the light source 102. It is possible to partially irradiate the light emitted from the light source 102 like a spotlight by providing the light shielding element 104 with the plurality of regions controllable to the light-shielding mode and the transmission mode. Since the transmission region of illumination light (the transmission mode region) controlled by the light shielding element 104 is freely adjustable in its position and range, lighting can be performed by changing the position of the spotlight or such that the spotlight appears to move continuously.

The present embodiment shows an example in which the common electrode COM is provided on the first substrate S01 of the liquid crystal panel 1044 and the drive electrode SE is provided on the second substrate S02. However, the configuration of the liquid crystal panel 1044 is not limited to this example, and the common electrode COM may be provided on the second substrate S02 while the drive electrode SE is provided on the first substrate S01. Furthermore, although the present embodiment shows a case in which the liquid crystal panel 1044 is of a TN type using twisted nematic liquid crystal, the liquid crystal panel 1044 can employ liquid crystal panels of various types such as a VA (Vertical Alignment) type, an MVA (Multi-domain Vertical Alignment) type, an IPS (In-Plane Switching) type, and an FFS (Fringe Field Switching) type, or a liquid crystal panel using polymer-dispersed liquid crystal.

### SECOND EMBODIMENT

The present embodiment shows a configuration in which a liquid crystal light control element 120 is added to the configuration of the lighting device 100 shown in the first embodiment.

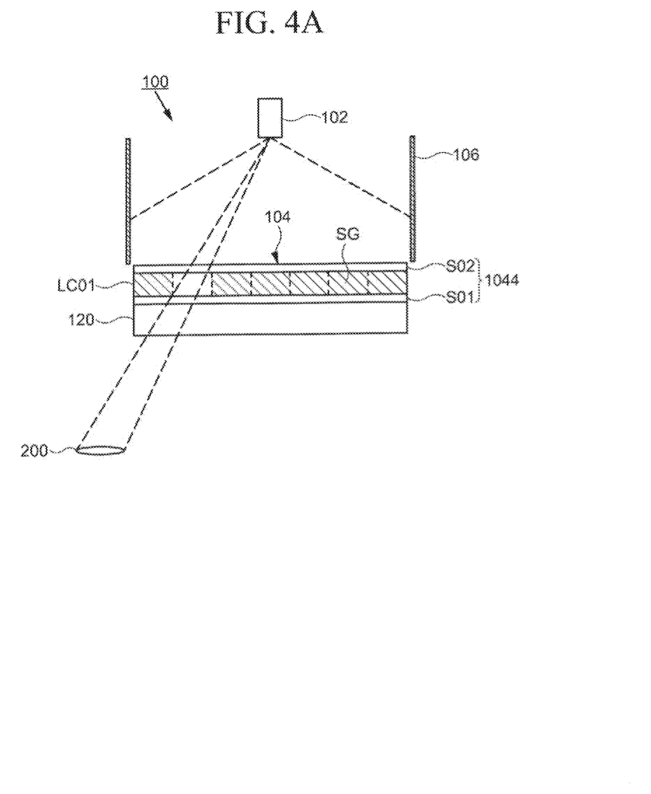

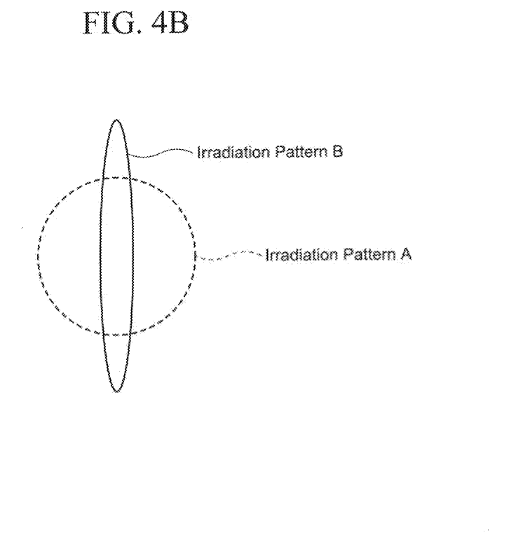

FIG. 4A illustrates a configuration of the lighting device 100 according to the present embodiment. The lighting device 100 according to the present embodiment includes the light source 102, the light shielding element 104, and the liquid crystal light control element 120. The liquid crystal light control element 120 is disposed on a light emission side of the light shielding element 104. The liquid crystal light control element 120 has a function of controlling a light distribution state (light spread). Specifically, it is possible to form a line-shaped light distribution pattern (line light distribution), a cross-shaped light distribution pattern (cross light distribution), a rectangular light distribution pattern, or the like by diffusing light in a specific direction with the liquid crystal light control element 120.

For example, FIG. 4B illustrates an irradiation pattern when a line light distribution is formed by the liquid crystal light control element 120. As shown in FIG. 4B, it is possible to form a line-shaped irradiation pattern B having a wider spread than an irradiation pattern A by passing light through the liquid crystal light control element 120, relative to the irradiation pattern A of the spotlight formed by the light shielding element 104. In this way, it is possible to irradiate the spotlight with a controlled light distribution state by passing the light through the liquid crystal light control element 120 in addition to the light shielding element 104.

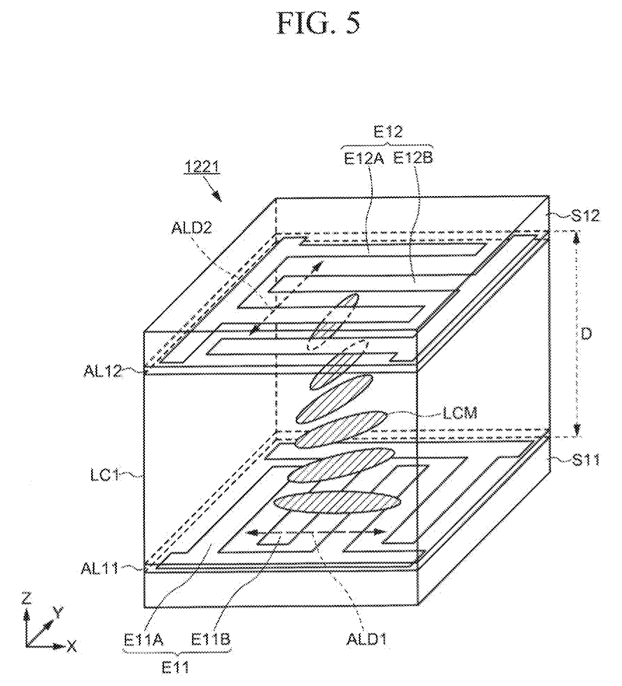

FIG. 5 illustrates a perspective view of a first liquid crystal cell 1221 constituting the liquid crystal light control element 120. The first liquid crystal cell 1221 includes a first substrate S11, a second substrate S12, a first electrode E11, a second electrode E12, a first alignment film AL11, a second alignment film AL12, and a first liquid crystal layer LC1. The first electrode E11 and the first alignment film AL11 are provided on the first substrate S11, and the second electrode E12 and the second alignment film AL12 are provided on the second substrate S12. The first alignment film AL11 is provided so as to cover the first electrode E11, and the second alignment film AL12 is provided so as to cover the second electrode E12. The first substrate S11 and the second substrate S12 are disposed apart from and facing each other. The first liquid crystal layer LC1 is provided between the first substrate S11 and the second substrate S12.

The first electrode E11 includes a first strip-shaped electrode E11A and a second strip-shaped electrode E11B each having a plurality of strip patterns. The second electrode E12 includes a third strip-shaped electrode E12A and a fourth strip-shaped electrode E12B each having a plurality of strip patterns. The first strip-shaped electrode E11A and the second strip-shaped electrode E11B are alternately arranged on an insulating surface of the first substrate S11, and the third strip-shaped electrode E12A and the fourth strip-shaped electrode E12B are alternately arranged on an insulating surface of the second substrate S12. The plurality of strip patterns of the first strip-shaped electrode E11A and the second strip-shaped electrode E11B extend such that their longitudinal direction is along the Y-axis direction. The plurality of strip patterns of the third strip-shaped electrode E12A and the fourth strip-shaped electrode E12B extend such that their longitudinal direction is along the X-axis direction. Accordingly, the direction in which the plurality of strip patterns of the third strip-shaped electrode E12A and the fourth strip-shaped electrode E12B extend is orthogonal to (intersects at 90 degrees) the direction in which the plurality of strip patterns of the first strip-shaped electrode E11A and the second strip-shaped electrode E11B extend. The relative arrangement between the first and second strip-shaped electrodes (E11A, E11B) and the third and fourth strip-shaped electrodes (E12A, E12B) is not limited to an orthogonal relationship, and it is possible to vary the arrangement within a range of ±10 degrees with respect to 90 degrees.

The alignment direction ALD1 of the first alignment film AL11 is oriented in a direction (the Y-axis direction) intersecting the direction in which the first strip-shaped electrode E11A and the second strip-shaped electrode E11B extend. The alignment direction ALD2 of the second alignment film AL12 is oriented in a direction (the X-axis direction) intersecting the direction in which the third strip-shaped electrode E12A and the fourth strip-shaped electrode E12B extend. It is possible to set the angle at which the alignment direction ALD1 intersects the direction in which the first strip-shaped electrode E11A and the second strip-shaped electrode E11B extend, as well as the angle at which the alignment direction ALD2 intersects the direction in which the third strip-shaped electrode E12A and the fourth strip-shaped electrode E12B extend, within a range of 90±10 degrees.

The first substrate S11 and the second substrate S12 are disposed facing each other with a gap of 10 µm or more therebetween. For example, the first substrate S11 and the second substrate S12 are disposed with a gap of 10 µm or more and 1000 µm or less, preferably 20 µm or more and 500 µm or less. The first liquid crystal layer LC1 provided between the first substrate S11 and the second substrate S12 has a thickness D. The first electrode E11 and the second electrode E12, and the first alignment film AL11 and the second alignment film AL12 are provided between the first substrate S11 and the second substrate S12, but film thicknesses of these members are negligibly small compared to the gap between the first substrate S11 and the second substrate S12. Therefore, it is possible to regard the gap between the first substrate S11 and the second substrate S12 as the thickness D of the first liquid crystal layer LC1. That is, it is possible to consider that the thickness D of the first liquid crystal layer LC1 has a magnitude of 10 µm or more and 1000 µm or less, preferably 20 µm or more and 500 µm or less. Note that although not illustrated in FIG. 5, a spacer may be provided between the first substrate S11 and the second substrate S12.

As for the liquid crystal material forming the first liquid crystal layer LC1, it is possible to use a twisted nematic liquid crystal, similar to the light shielding element 104. As schematically illustrated in FIG. 5, liquid crystal molecules have an elongated rod-like structure due to their molecular structure. The liquid crystal molecules having the rod-like structure possess dielectric anisotropy and refractive index anisotropy between a long-axis direction (a direction parallel to the molecular long axis) and a short-axis direction (a direction orthogonal to the molecular long axis). The first liquid crystal cell 1221 is provided with the first alignment film AL11 and the second alignment film AL12 in order to control an alignment direction of the liquid crystal molecules. FIG. 5 illustrates a state in which the alignment direction ALD1 of the first alignment film AL11 is a direction parallel to the Y-axis and the alignment direction ALD2 of the second alignment film AL12 is a direction parallel to the X-axis.

In a state in which no control signal is applied to the first electrode E11 and the second electrode E12, the liquid crystal molecules LCM of the first liquid crystal layer LC1 are aligned such that the long-axis direction of the liquid crystal molecules LCM follows the alignment directions ALD1 and ALD2 of the alignment films due to the alignment regulating force of the first alignment film AL11 and the second alignment film AL12. Since the alignment direction ALD1 of the first alignment film AL11 and the alignment direction ALD2 of the second alignment film AL12 intersect each other (are orthogonal to each other), the alignment direction of the long-axis direction of the liquid crystal molecules LCM gradually changes so as to twist by 90 degrees from the first substrate S11 to the second substrate S12.

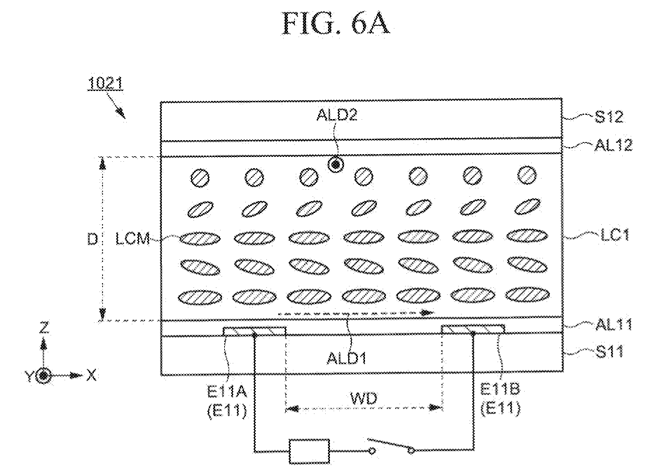

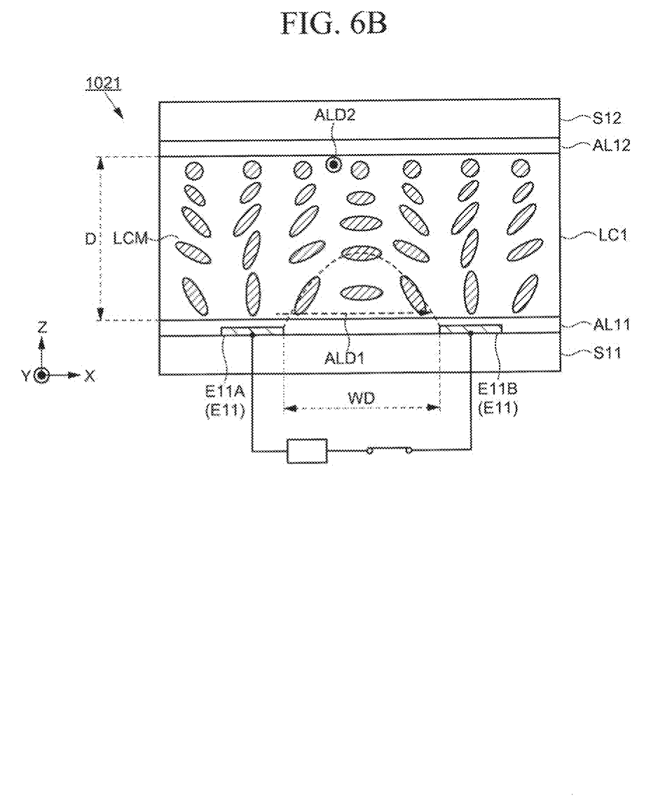

FIG. 6A and FIG. 6B are diagrams for explaining an operation of the first liquid crystal cell 1221. FIG. 6A illustrates a state in which no control signal is applied to the first electrode E11 (the first strip-shaped electrode E11A and the second strip-shaped electrode E11B), and FIG. 6B illustrates a state in which a control signal is applied to the first electrode E11 and a lateral electric field is generated between the first strip-shaped electrode E11A and the second strip-shaped electrode E11B. Note that the control signal is a voltage signal that generates a lateral electric field between the first strip-shaped electrode E11A and the second strip-shaped electrode E11B such that it is possible to align the orientation state of the liquid crystal molecules LCM in a direction parallel to the electric field. The same applies to control signals for the third strip-shaped electrode E12A and the fourth strip-shaped electrode E12B.

The first strip-shaped electrode E11A and the second strip-shaped electrode E11B are disposed with an interval WD therebetween, and the longitudinal direction of the strip patterns extends in the X-axis direction. Here, comparing the thickness D of the first liquid crystal layer LC1 with the electrode spacing WD of the first electrode E11, the thickness D of the first liquid crystal layer LC1 has a magnitude equal to or greater than the electrode spacing WD (D ≥ WD). For example, the thickness D of the first liquid crystal layer LC1 is twice or more the magnitude of the electrode spacing WD of the first electrode E11. It is possible to set the electrode spacing WD to 5 µm when the thickness D of the first liquid crystal layer LC1 is 10 µm, and it is possible to set the electrode spacing WD to 10 µm when the thickness D of the first liquid crystal layer LC1 is 50 µm.

The alignment direction ALD1 of the first alignment film AL11 extends in the X-axis direction, and the alignment direction ALD2 of the second alignment film AL12 extends in the Y-axis direction. In a state in which an electric field is not acting on the first liquid crystal layer LC1 (FIG. 6A), the liquid crystal molecules are aligned in a state twisted by 90 degrees from the first substrate S11 side to the second substrate S12 side. At this time, the first liquid crystal layer LC1 has a uniform refractive index distribution. When light enters the first liquid crystal cell 1221, a polarization component of the incident light is optically rotated due to the twist of the liquid crystal molecules LCM. The incident light passes through the first liquid crystal layer LC1 without being refracted (or scattered) while being optically rotated.

When a control signal is applied to the first electrode E11 and the lateral electric field is generated between the first strip-shaped electrode E11A and the second strip-shaped electrode E11B, the long axes of the liquid crystal molecules LCM are aligned along the electric field (in a case in which the liquid crystal has a positive dielectric anisotropy). As a result, as shown in FIG. 6B, a region in which the liquid crystal molecules LCM rise above the first strip-shaped electrode E11A and the second strip-shaped electrode E11B and a region in which they are aligned obliquely along a distribution of the electric field between the first strip-shaped electrode E11A and the second strip-shaped electrode E11B are formed. At this time, if the thickness D of the first liquid crystal layer LC1 is sufficiently large (10 µm or more), the influence of the electric field formed by the first electrode E11 does not reach the second substrate S12 side, and the alignment state of the liquid crystal molecules LCM changes only on the first substrate S11 side. That is, the liquid crystal molecules LCM on the second substrate S12 side are not affected by the electric field, and a state in which the alignment does not change is maintained.

As shown in FIG. 6B, when the lateral electric field is generated between the first strip-shaped electrode E11A and the second strip-shaped electrode E11B, the liquid crystal molecules LCM are aligned such that the long axes of the liquid crystal molecules are in a convex arc shape along the direction in which the electric field is generated. In the liquid crystal having dielectric anisotropy, a distribution of a dielectric constant also changes into an arc shape due to this change in the alignment state of the liquid crystal molecules LCM. When light enters from the first substrate S11 side in this state, a polarization component parallel to the X-axis direction is diffused in a divergent manner by the dielectric constant distribution. Thereafter, the polarization component parallel to the X-axis direction is optically rotated by 90 degrees in the process of traveling from the first substrate S11 to the second substrate S12. On the other hand, a polarization component parallel to the Y-axis direction enters the first liquid crystal layer LC1 without being affected by the dielectric constant distribution and without being diffused, and is optically rotated by 90 degrees in the process of traveling from the first substrate S11 to the second substrate S12.

In this way, it is possible to diffuse (expand a luminous intensity distribution of) a specific polarization component of the incident light by aligning the liquid crystal molecules LCM in a predetermined direction and changing the alignment state thereof with the lateral electric field. Note that although FIG. 6A and FIG. 6B explain the effect that the first electrode E11 exerts on the liquid crystal molecules LCM and the incident light, the same applies to the effect that the second electrode E12 of the second substrate S12 exerts on the first liquid crystal layer LC1. That is, on the second substrate S12 side, it is possible to diffuse (expand the luminous intensity distribution of) the polarization component parallel to the Y-axis direction by generating a lateral electric field with the second electrode E12.

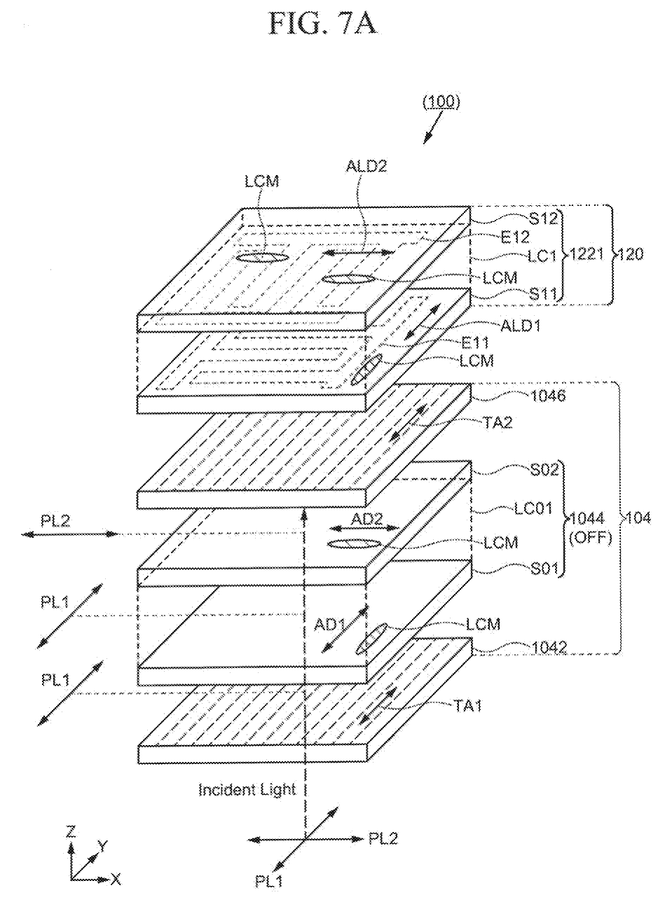

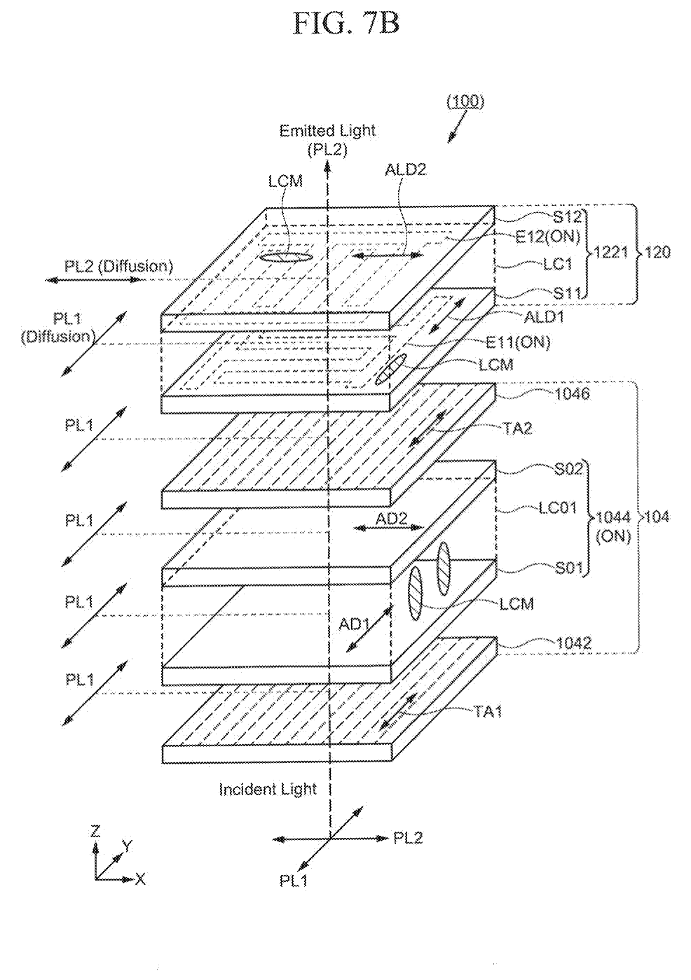

FIG. 7A is a perspective view illustrating a first configuration of the lighting device 100 according to the present embodiment. In the lighting device 100 according to the first configuration, the light shielding element 104 and the liquid crystal light control element 120 are arranged in this order from the light source 102 side, as described with reference to FIG. 4A. Furthermore, the light shielding element 104 has a configuration similar to the light shielding element shown in FIG. 3. That is, the light shielding element 104 has a configuration in which the first polarizing plate 1042 and the second polarizing plate 1046 are disposed with the liquid crystal panel 1044 interposed therebetween. Transmission polarization axes of the first polarizing plate 1042 and the second polarizing plate 1046 are arranged parallel to the Y-axis direction.

In FIG. 7A, the liquid crystal panel 1044 constituting the light shielding element 104 illustrates only the first substrate S01, the second substrate S02, and the liquid crystal layer LC01, while the common electrode COM, the drive electrode SE, the first alignment film AF01, the second alignment film AF02, and the like are omitted. Note that in FIG. 7A, alignment directions AD1 and AD2 of the first alignment film AF01 and the second alignment film AF02 are indicated by arrows. The alignment direction AD1 of the first alignment film (not shown) on the first substrate S01 side is in the same direction as the Y-axis direction, and the alignment direction AD2 of the second alignment film (not shown) on the second substrate S02 side is in the same direction as the X-axis direction.

The liquid crystal light control element 120 has a configuration similar to that of the liquid crystal light control element shown in FIG. 5. Note that strip patterns of the first electrode E11 extend in the X-axis direction, and strip patterns of the second electrode E12 extend in the Y-axis direction. In FIG. 7A, as other components of the first liquid crystal cell 1221, the first alignment film AL11, the second alignment film AL12, and the like are omitted. Note that in FIG. 7A, alignment directions ALD1 and ALD2 of a first alignment film (not shown) and a second alignment film (not shown) of the first liquid crystal cell 1221 are indicated by arrows. The alignment direction ALD1 of the first alignment film is in the same direction as the Y-axis direction, and the alignment direction ALD2 of the second alignment film (not shown) is in the same direction as the X-axis direction.

Next, an operation of the lighting device 100 shown in FIG. 7A will be described. The lighting device 100 shown in FIG. 7A has an optical path in which light emitted from the light source 102 (not shown) passes through the light shielding element 104 and then passes through the liquid crystal light control element 120 to be emitted to the outside. In FIG. 7A, an emission direction of the light (the first polarization component PL1 and the second polarization component PL2) emitted from the light source 102 (not shown) is indicated by arrows pointing from the bottom to the top of the drawing.

FIG. 7A illustrates a case in which the light shielding element 104 is in an OFF state (light-shielding state). The first polarization component PL1 and the second polarization component PL2 enter the first polarizing plate 1042. The transmission polarization axis TA1 of the first polarizing plate 1042 is in the same direction as the Y-axis direction. Accordingly, regarding the light entering the first polarizing plate 1042, the first polarization component PL1 is transmitted while the second polarization component PL2 is absorbed. Note that, as described with reference to FIG. 3, in a case in which the first brightness enhancement film 1048A is provided, the second polarization component PL2 is reflected by the first brightness enhancement film 1048A.

The first polarization component PL1 transmitted through the first polarizing plate 1042 enters the liquid crystal panel 1044. The first polarization component PL1 having entered the liquid crystal panel 1044 is optically rotated by 90 degrees and transitions to the second polarization component PL2 because the liquid crystal molecules of the liquid crystal layer LC01 are aligned in a state in which they are twisted by 90 degrees from the first substrate S01 to the second substrate S02. Since the transmission polarization axis of the second polarizing plate 1046 is oriented in the Y-axis direction, the second polarization component PL2 emitted from the liquid crystal panel 1044 is absorbed by the second polarizing plate 1046, however, in a case in which the second brightness enhancement film 1048B is provided, the second polarization component PL2 is reflected there. Accordingly, when the light shielding element 104 is in the OFF state, the light emitted from the light source 102 is shielded and is not emitted to the outside.

FIG. 7B illustrates a state in which the light shielding element 104 is in an ON state (transmission state), control signals are applied to the first electrode E11 and the second electrode E12 of the liquid crystal light control element 120 (ON state), and a lateral electric field is generated in a direction parallel to the alignment directions ALD1 and ALD2.

In a case in which the light shielding element 104 is in the ON state, the first polarization component PL1 incident on the liquid crystal panel 1044 does not undergo optical rotation in the liquid crystal layer LC01 and passes directly through the second polarizing plate 1046. The first polarization component PL1 having entered the liquid crystal light control element 120 enters the first liquid crystal cell 1221 constituting the liquid crystal light control element 120. In the first liquid crystal cell 1221, on the first substrate S11 side, the liquid crystal molecules LCM form an arc-shaped dielectric constant distribution by an electric field parallel to the Y-axis direction (alignment direction ALD1). The direction of the polarization axis of the first polarization component PL1 having entered the first liquid crystal cell 1221 is parallel to the Y-axis direction (alignment direction ALD1). Therefore, it is possible to diffuse the first polarization component PL1 in the Y-axis direction by the dielectric constant distribution formed by the liquid crystal molecules LCM. In the process of the first polarization component PL1 passing through the first liquid crystal layer LC1 from the first substrate S11 to the second substrate S12, it is optically rotated by 90 degrees by the liquid crystal molecules LCM aligned in a twisted manner by 90 degrees and transitions to the second polarization component PL2. On the second substrate S12 side, the liquid crystal molecules LCM form an arc-shaped dielectric constant distribution by an electric field generated in a direction parallel to the X-axis direction (alignment direction ALD2). Since the direction of the polarization axis of the second polarization component PL2 is parallel to the X-axis direction (alignment direction ALD2), it is possible to diffuse the second polarization component PL2 in the X-axis direction by the dielectric constant distribution formed by the liquid crystal molecules LCM. Then, the second polarization component PL2 is emitted from the first liquid crystal cell 1221.

As described above, the light emitted from the light source 102 undergoes a process in which the first polarization component PL1 passes through the light shielding element 104 and is diffused in the X-axis direction by the liquid crystal light control element 120, and after transitioning to the second polarization component PL2, the light is further diffused in the X-axis direction and emitted.

Note that FIG. 7B illustrates a state in which control signals are applied to both the first electrode E11 and the second electrode E12 of the liquid crystal light control element 120, but the control signals applied to the liquid crystal light control element 120 are not limited to this example. It is possible to apply the control signal to only one of the first electrode E11 and the second electrode E12, or it is possible not to apply the control signals to either of them.

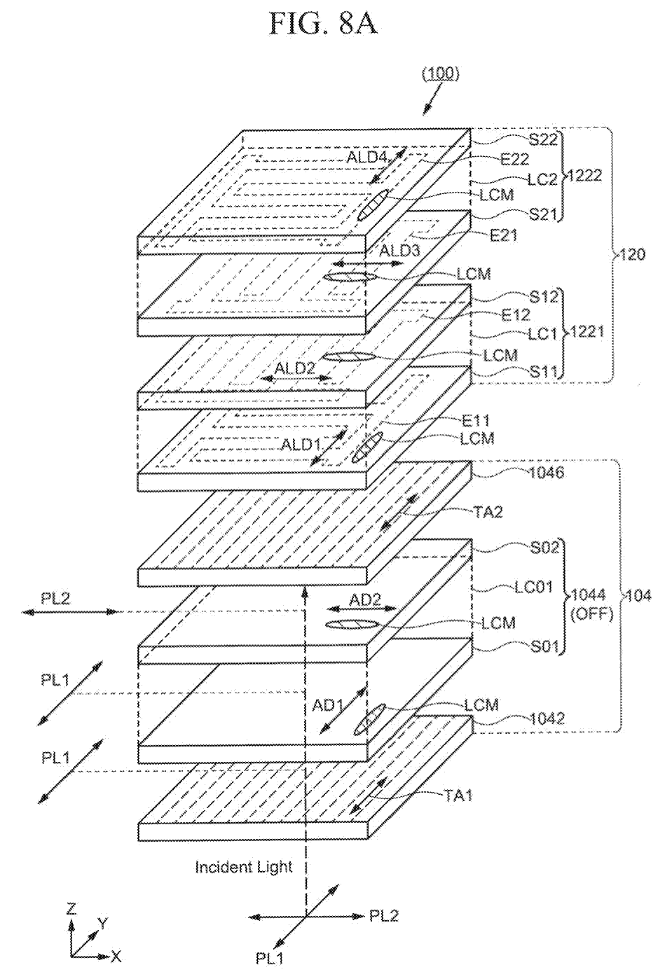

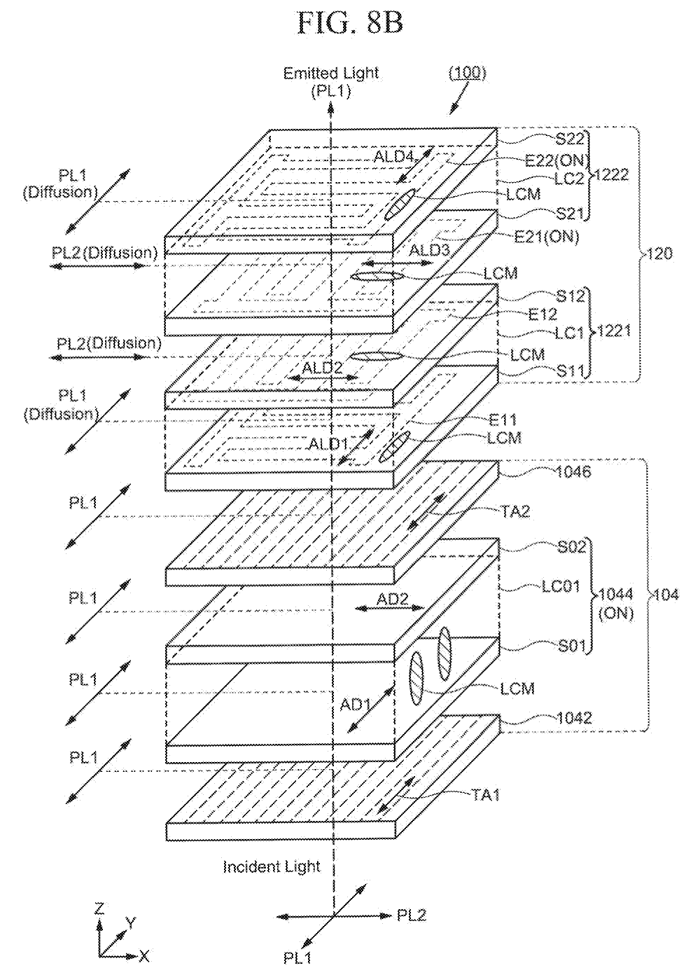

FIG. 8A is a perspective view illustrating a second configuration of the lighting device 100 according to the present embodiment. The second configuration has a configuration in which the liquid crystal light control element 120 includes two liquid crystal cells: the first liquid crystal cell 1221 and a second liquid crystal cell 1222. The first liquid crystal cell 1221 and the second liquid crystal cell 1222 are stacked such that light enters from the first liquid crystal cell 1221 side and is emitted from the second liquid crystal cell 1222 side. The configuration of the first liquid crystal cell 1221 is similar to the configuration shown in FIG. 7A. The second liquid crystal cell 1222 has a configuration in which an alignment direction ALD3 of a first alignment film on a first substrate S21 side is oriented in the X-axis direction and an alignment direction ALD4 of a second alignment film on a second substrate S22 side is oriented in the Y-axis direction.

FIG. 8A illustrates a case in which the light shielding element 104 is in an OFF state. In this case, the operation of the lighting device 100 is similar to the example shown in FIG. 7A, and light emitted from the light source 102 is blocked, resulting in a state in which no light is emitted to the outside.

FIG. 8B illustrates a state in which the light shielding element 104 is in an ON state and control signals are applied to electrodes of the first liquid crystal cell 1221 and the second liquid crystal cell 1222 of the liquid crystal light control element 120. In a case in which the light shielding element 104 is in the ON state, the first polarization component PL1 among polarization components emitted from the light source 102 (not shown) is emitted from the light shielding element 104. Then, regarding the first polarization component PL1 having entered the liquid crystal light control element 120, it is possible to diffuse the first polarization component PL1 in the Y-axis direction on the first substrate S11 side of the first liquid crystal cell 1221. After the first polarization component PL1 is optically rotated by 90 degrees in the first liquid crystal layer LC1 and transitions to the second polarization component PL2, it is possible to diffuse the light in the X-axis direction on the second substrate S12 side. The second polarization component PL2 having entered the second liquid crystal cell 1222 is diffused in the X-axis direction on the first substrate S21 side. After the second polarization component PL2 is optically rotated by 90 degrees in a second liquid crystal layer LC2 and transitions to the first polarization component PL1, it is possible to diffuse the light in the Y-axis direction on the second substrate S22 side and emit the light.

In this way, according to the second configuration of the lighting device 100, the first polarization component PL1 emitted from the light shielding element 104 is diffused twice in each of the X-axis direction and the Y-axis direction and is optically rotated twice by an angle of 90 degrees, so that it is possible to emit the light in a state in which it remains the first polarization component PL1.

Note that FIG. 8B illustrates a case in which control signals are applied to all electrodes of the first liquid crystal cell 1221 and the second liquid crystal cell 1222, but the operation of the lighting device 100 according to the second configuration is not limited to this example. For example, it is possible to operate the device in a mode in which a polarized wave is diffused twice in the X-axis direction by applying control signals only to the second electrode E12 of the first liquid crystal cell 1221 and a first electrode E21 of the second liquid crystal cell 1222. Furthermore, it is possible to operate the device in a mode in which the polarized wave is diffused once in each of the X-axis direction and the Y-axis direction by applying control signals only to the first electrode E11 of the first liquid crystal cell 1221 and the first electrode E21 of the second liquid crystal cell 1222.

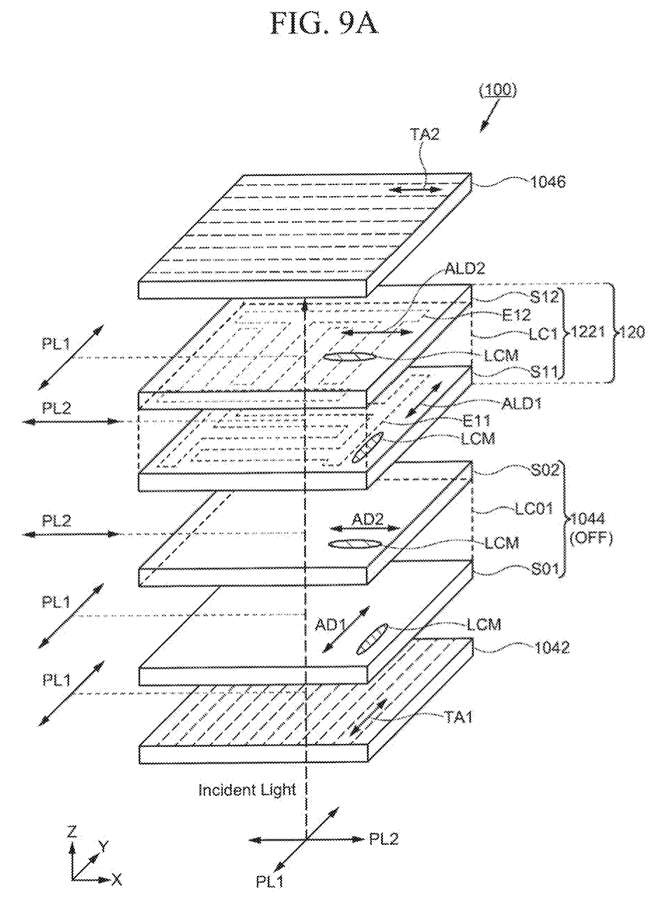

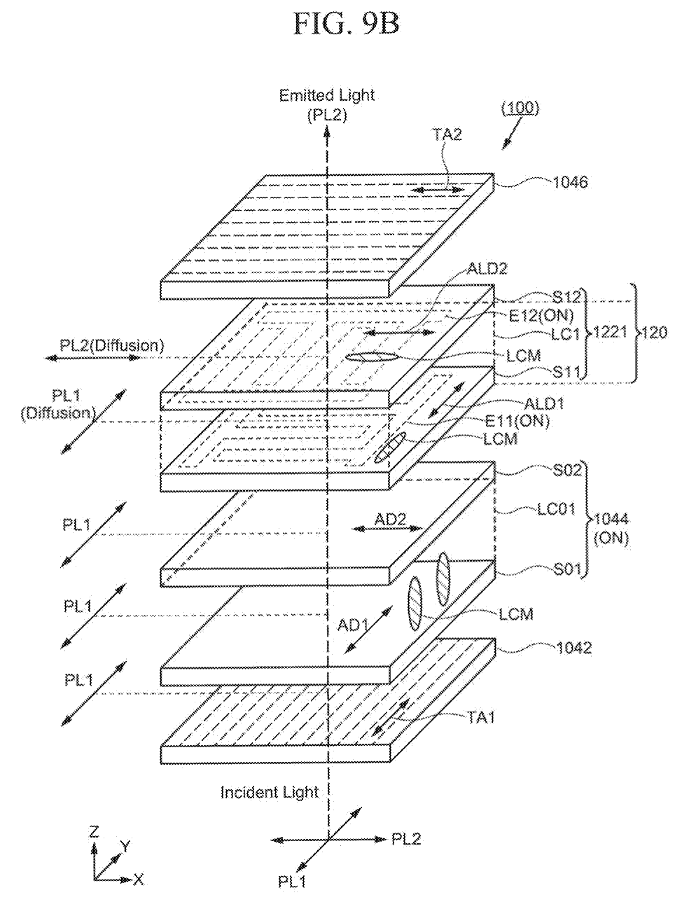

FIG. 9A is a perspective view illustrating a third configuration of the lighting device 100 according to the present embodiment. FIG. 9A illustrates a configuration in which the position and the direction of the transmission axis of the second polarizing plate 1046 are changed relative to the configuration of the lighting device 100 according to the first configuration. Specifically, the lighting device 100 according to the third configuration has a configuration in which the second polarizing plate 1046 is disposed outside the liquid crystal light control element 120. Further, the transmission polarization axis of the second polarizing plate 1046 is oriented in the X-axis direction.

FIG. 9A illustrates a state in which the light shielding element 104 is in an OFF state and no control signals are applied to the first electrode E11 and the second electrode E12 of the first liquid crystal cell 1221. In this state, the first polarization component PL1 having passed through the first polarizing plate 1042 is optically rotated by 90 degrees by the light shielding element 104, transitions to the second polarization component PL2, and enters the first liquid crystal cell 1221. In the first liquid crystal cell 1221, the second polarization component PL2 is optically rotated by 90 degrees in the first liquid crystal layer LC1 and transitions to the first polarization component PL1, however, since a state exists in which neither the first electrode E11 nor the second electrode E12 generates a lateral electric field, no diffusion occurs. Since the transmission axis of the second polarizing plate 1046 is oriented in the X-axis direction, the first polarization component PL1 emitted from the first liquid crystal cell 1221 is absorbed without being transmitted. Accordingly, light emitted from the light source 102 is blocked.

On the other hand, FIG. 9B illustrates a state in which the light shielding element 104 is in an on state and control signals are applied to the first electrode E11 and the second electrode E12 of the first liquid crystal cell 1221. Under this condition, the first polarization component PL1 having passed through the first polarizing plate 1042 enters the first liquid crystal cell 1221 without being optically rotated by the light shielding element 104. In the first liquid crystal cell 1221, it is possible to diffuse the first polarization component PL1 in the Y-axis direction on the first substrate S11 side. Then, after the first polarization component PL1 is optically rotated by 90 degrees in the first liquid crystal layer LC1 and transitions to the second polarization component PL2, it is possible to diffuse the light in the X-axis direction on the second substrate S12 side. Since the transmission axis of the second polarizing plate 1046 is oriented in the X-axis direction, the second polarization component PL2 is transmitted through the second polarizing plate 1046 and is emitted.

As described above, the lighting device 100 according to the third configuration undergoes a process in which the first polarization component PL1 is diffused in the Y-axis direction by the liquid crystal light control element 120, and after the light is optically rotated by 90 degrees in the first liquid crystal cell 1221 to become the second polarization component PL2, it is possible to diffuse the light in the X-axis direction and emit it.

Note that FIG. 9B illustrates a case in which control signals are applied to both the first electrode E11 and the second electrode E12 of the first liquid crystal cell 1221, but the operation of the lighting device 100 according to the third configuration is not limited to this example. For example, it is possible to operate the device in a mode in which the polarized wave is diffused in either the X-axis direction or the Y-axis direction by applying the control signals to only one of the first electrode E11 and the second electrode E12.

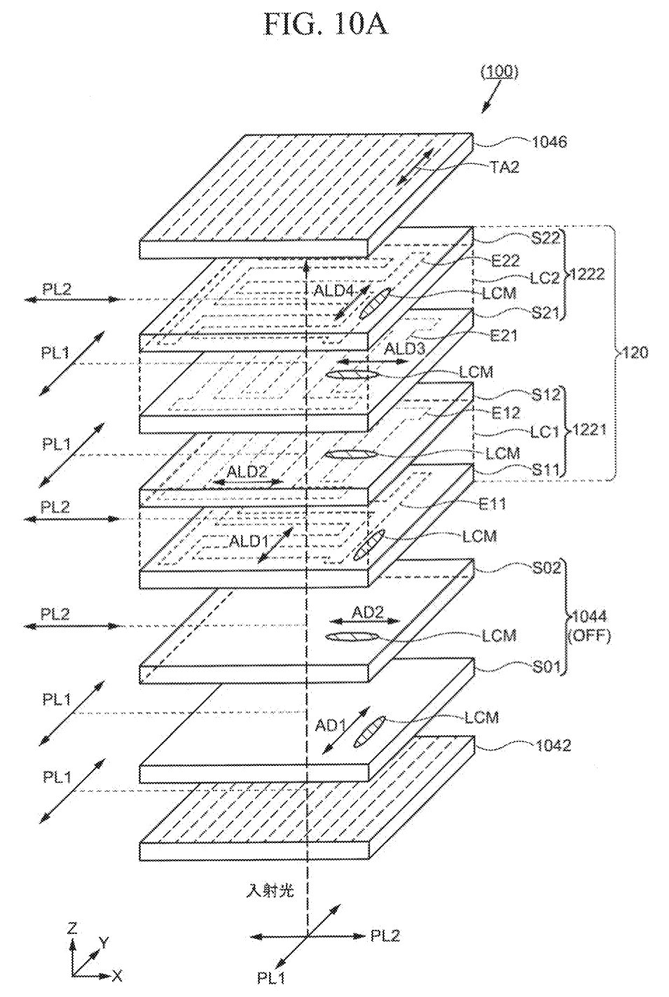

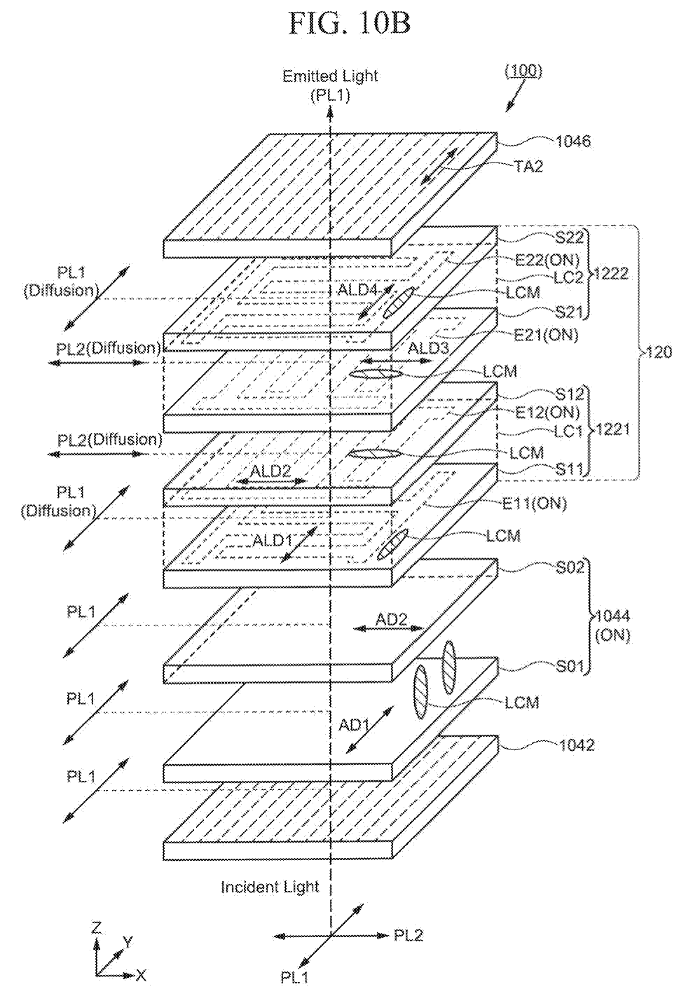

FIG. 10A is a perspective view illustrating a fourth configuration of the lighting device 100 according to the present embodiment. FIG. 10A illustrates a configuration in which the lighting device 100 differs from the lighting device 100 according to the third configuration in that the liquid crystal light control element 120 is composed of the first liquid crystal cell 1221 and the second liquid crystal cell 1222, and in which a transmission polarization axis TA2 of the second polarizing plate 1046 is arranged in the same direction as the transmission polarization axis TA1 of the first polarizing plate 1042.

FIG. 10A illustrates a state in which the light shielding element 104 is in an OFF state and no control signals are applied to the liquid crystal light control element 120. As described with reference to FIG. 9A, the first polarization component PL1 having passed through the first polarizing plate 1042 is optically rotated by 90 degrees by the liquid crystal panel 1044 and transitions to the second polarization component PL2. The second polarization component PL2 emitted from the light shielding element 104 enters the first liquid crystal cell 1221 of the liquid crystal light control element 120. Since a state exists in which no control signals are applied to the first electrode E11 and the second electrode E12 of the first liquid crystal cell 1221, the second polarization component PL2 is not diffused, is optically rotated by 90 degrees in the first liquid crystal layer LC1, and transitions to the first polarization component PL1. The first polarization component PL1 emitted from the first liquid crystal cell 1221 enters the second liquid crystal cell 1222. Since a state exists in which no control signals are applied to the first electrode E21 and the second electrode E22 of the second liquid crystal cell 1222, the first polarization component PL1 is not diffused, is optically rotated by 90 degrees in the second liquid crystal layer LC2, and transitions to the second polarization component PL2 to enter the second polarizing plate 1046. The transmission polarization axis of the second polarizing plate 1046 is oriented in the Y-axis direction and crosses the second polarization component PL2. Accordingly, the second polarization component PL2 emitted from the liquid crystal light control element 120 is absorbed by the second polarizing plate 1046 and is not emitted to the outside, that is, light emitted from the light source 102 is blocked.

On the other hand, FIG. 10B illustrates a state in which the light-shielding element 104 is in an ON state, and control signals are applied to the first electrode E11 and the second electrode E12 of the first liquid crystal cell 1221, and the first electrode E21 and the second electrode E22 of the second liquid crystal cell 1222. In this state, the first polarization component PL1 having passed through the first polarizing plate 1042 enters the first liquid crystal cell 1221 without being optically rotated by the light-shielding element 104. Regarding the first polarization component PL1, it is possible to diffuse the light in the Y-axis direction on the first substrate S11 side. After the light is optically rotated by 90 degrees in the first liquid crystal layer LC1 and transitions to the second polarization component PL2, it is possible to diffuse the light in the X-axis direction on the second substrate S12 side. The second polarization component PL2 emitted from the first liquid crystal cell 1221 enters the second liquid crystal cell 1222. Regarding the second polarization component PL2, it is possible to diffuse the light in the X-axis direction on the first substrate S21 side. After the light is optically rotated by 90 degrees in the second liquid crystal layer LC2 and transitions to the first polarization component PL1, it is possible to diffuse the light in the Y-axis direction on the second substrate S22 side. Since the transmission axis of the second polarizing plate 1046 is oriented in the Y-axis direction, the first polarization component PL1 is transmitted through the second polarizing plate 1046 and emitted.

As described above, according to the fourth configuration of the lighting device 100, in the process of the light passing through the liquid crystal light control element 120, the first polarization component PL1 emitted from the light shielding element 104 is diffused twice in each of the X-axis direction and the Y-axis direction and is optically rotated twice by an angle of 90 degrees, so that it is possible to emit the light in a state in which it remains the first polarization component PL1.

Note that FIG. 10B illustrates a case in which control signals are applied to all electrodes of the first liquid crystal cell 1221 and the second liquid crystal cell 1222, but the operation of the lighting device 100 according to the fourth configuration is not limited to this example. For example, it is possible to operate the device in a mode in which a polarized wave is diffused twice in the X-axis direction by applying the control signals only to the second electrode E12 of the first liquid crystal cell 1221 and the first electrode E21 of the second liquid crystal cell 1222. Alternatively, it is possible to operate the device in a mode in which the polarized wave is diffused once in each of the X-axis direction and the Y-axis direction by applying the control signals only to the first electrode E11 of the first liquid crystal cell 1221 and the first electrode E21 of the second liquid crystal cell 1222.

According to the lighting device 100 of the present embodiment, it is possible to not only irradiate light emitted from the light source 102 as a spotlight by using the light shielding element 104, but also to irradiate an arbitrarily selected area as a spotlight by using the liquid crystal light control element 120 to output light in which a light distribution state is controlled.

### THIRD EMBODIMENT

The present embodiment illustrates a configuration in which drive electrodes are provided in the light shielding element 104.

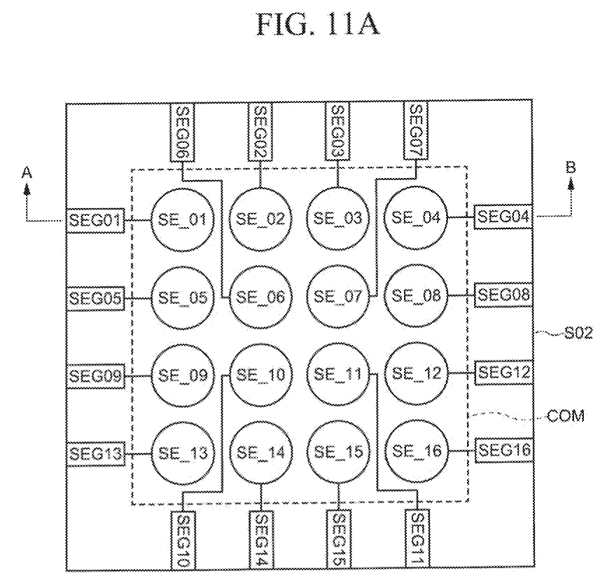

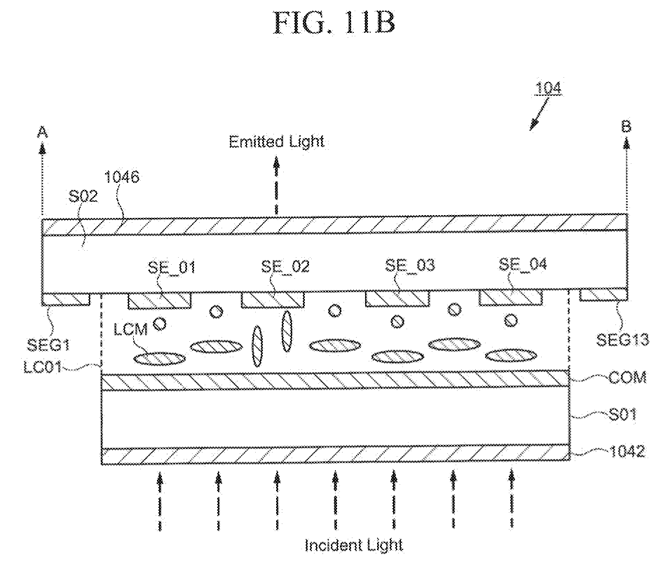

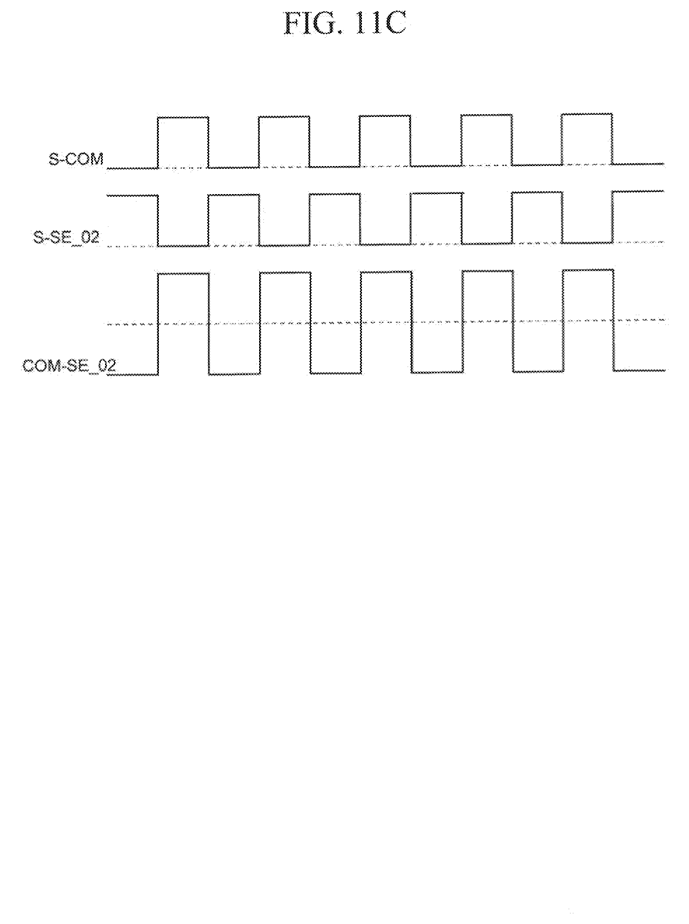

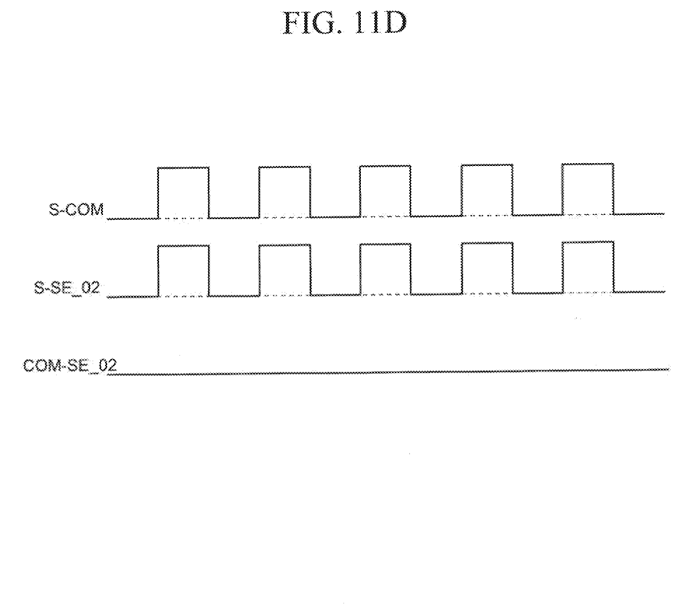

FIG. 11A is a plan view illustrating a configuration of the light shielding element 104 on the second substrate S02 side. A plurality of drive electrodes SE_01 to SE_16 are provided on the second substrate S02. The plurality of drive electrodes SE_01 to SE_16 have a configuration in which they are arranged, for example, in a matrix. On the second substrate S02, a plurality of input terminals SEG01 to SEG16 for applying voltages to the plurality of drive electrodes SE_01 to SE_16 are also provided. The shapes of the plurality of drive electrodes SE_01 to SE_16 in a plan view are, for example, circular. Although there is no limitation on the size of the drive electrodes SE, it is possible to, for example, make the size such that the diameter is 1 mm to 100 mm. Further, it is possible for the sizes of the plurality of drive electrodes SE_01 to SE_16 to be the same, or it is possible for the drive electrodes to be arranged such that drive electrodes of different sizes are mixed. Note that although FIG. 11A illustrates the plurality of drive electrodes SE_01 to SE_16, the number of drive electrodes is not limited to the illustrated example, and it is possible to set the number appropriately.

Regarding the size of each of the plurality of drive electrodes SE_01 to SE_16 (a diameter for a circle, a side length for a rectangle, or a diagonal length for a polygon), it is possible to set the size to several millimeters to several tens of millimeters. For example, in a case in which the shape of the plurality of drive electrodes SE_01 to SE_16 is circular, it is possible to set the diameter to 2 mm to 40 mm. Furthermore, the shape of the plurality of drive electrodes SE_01 to SE_16 in a plan view is not limited to a circle, and it is possible to replace the shape with other shapes such as a quadrangle, a triangle, a hexagon, or an ellipse. Note that although FIG. 11A illustrates an arrangement of 16 drive electrodes as an example, there is no particular limitation on the number of drive electrodes SE. Additionally, a plurality of input terminals SEG01 to SEG16 for applying voltages to the plurality of drive electrodes SE_01 to SE_16 are provided. The plurality of input terminals SEG01 to SEG16 are provided corresponding to the plurality of drive electrodes SE_01 to SE_16, and have a configuration in which they are connected by wiring.

FIG. 11B illustrates a cross-sectional structure of the light shielding element 104 corresponding to a line A-B shown in FIG. 11A. The plurality of drive electrodes SE_01 to SE_16 (FIG. 11B illustrates the drive electrodes SE_01 to SE_04) are provided on the second substrate S02 and have a configuration in which they are arranged to face the common electrode COM provided on the first substrate S01. The liquid crystal layer LC01 is provided between the plurality of drive electrodes SE_01 to SE_16 and the common electrode COM. The plurality of input terminals SEG01 to SEG16 have a configuration in which they are arranged in an outer region so as not to overlap with the common electrode COM. Control signals from an external control circuit are input to the plurality of input terminals SEG01 to SEG16.

As described with reference to FIG. 3, in a case in which a voltage for changing the alignment state of the liquid crystal is applied between each of the drive electrodes SE_01 to SE_16 and the common electrode COM, the corresponding region changes to a transmission mode, and a region in which light emitted from the light source 102 is transmitted is formed. As shown in FIG. 11A, in a case in which the shape of the drive electrode SE is circular, it is possible to irradiate a circular spotlight.

FIG. 11C and FIG. 11D illustrate an example of drive signals for driving the light shielding element 104. FIG. 11C illustrates, as an example, drive signals for turning the drive electrode SE_02 shown in FIG. 11B to an ON state (transmission mode). Specifically, FIG. 11C illustrates a drive signal S-COM applied to the common electrode COM, a drive signal S-SE_02 applied to the drive electrode SE_02, and a voltage between the common electrode COM and the drive electrode SE_02 in a state in which the common electrode COM is viewed as being at a ground (GND) level. Pulse signals in anti-phase are input to the common electrode COM and the drive electrode SE_02. By using such drive signals, it is possible to perform common inversion driving in which a voltage level between the common electrode COM and the drive electrode SE_02 is inverted when the common electrode COM is viewed as being at the ground (GND) level.

FIG. 11D illustrates drive signals for turning the drive electrode SE_02 to an OFF state (shielding mode). In a case in which the light shielding element 104 is driven in the shielding mode, it is possible to input pulse signals in phase as a drive signal S-COM applied to the common electrode COM and a drive signal S-SE_02 applied to the drive electrode SE_02. By using such drive signals, it is possible to achieve a state in which the voltage levels of the common electrode COM and the drive electrode SE_02 are the same when the common electrode COM is viewed as being at a ground (GND) level, such that no potential difference occurs between the common electrode COM and the drive electrode SE_02.

Note that although FIG. 11C and FIG. 11D illustrate the drive signals applied to the common electrode COM and the drive electrode SE_02, it is possible to drive the other drive electrodes in a similar manner. That is, in a state in which a constant pulse signal is input to the common electrode COM, it is possible to irradiate a spotlight on a specific region by inputting drive signals for a transmission mode or drive signals for a shielding mode to the plurality of drive electrodes SE_01 to SE_16, and it is possible to move an irradiation position of the spotlight within an irradiation range of the illumination light.

It is possible to apply the configuration shown in the present embodiment to the light shielding element 104 described in the first embodiment and the second embodiment. Furthermore, it is possible to configure the lighting device 100 by using the light shielding element 104 shown in the present embodiment.

### FOURTH EMBODIMENT

The present embodiment illustrates a configuration in which a light shielding layer is added to the light shielding element 104 described in the first embodiment.

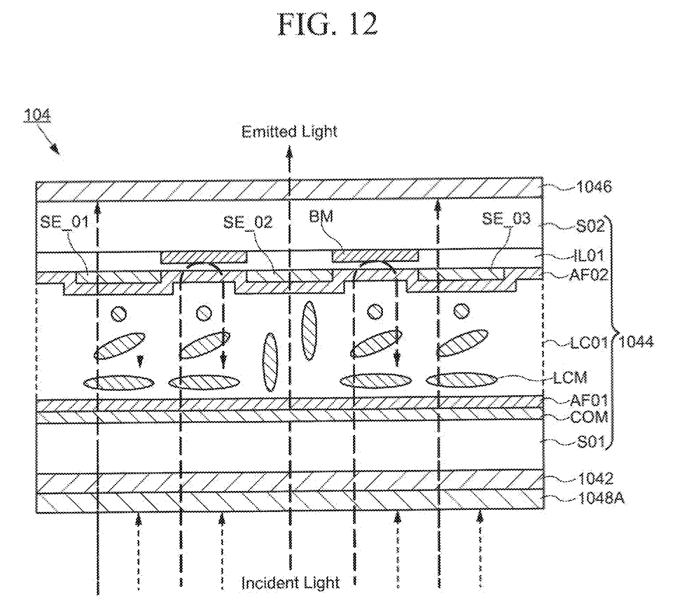

FIG. 12 is a cross-sectional view illustrating the light-shielding element 104 according to the present embodiment. The light-shielding element 104 according to the present embodiment has the same configuration as the light-shielding element 104 shown in the first embodiment (refer to FIG. 3), except for a configuration in which a light-shielding layer BM is provided. Hereinafter, descriptions will be given focusing on parts different from the light-shielding element shown in the first embodiment.

The light-shielding layer BM is arranged in regions between the drive electrodes SE_01 to SE_03. The light-shielding layer BM has a configuration in which it is provided so as to fill the regions between the drive electrodes SE_01 to SE_03. It is possible to form the light-shielding layer BM using a metal material, or it is possible to form it using a resin material. As the metal material, it is possible to use a metal material having low reflectivity, such as titanium (Ti), molybdenum (Mo), or a molybdenum-tungsten alloy (MoW). As the resin material, it is possible to use a resin material containing a black pigment.

In a case in which the light-shielding layer BM is formed of a resin material and has an insulating property, it is possible to form the light-shielding layer BM in the same layer as the drive electrodes SE_01 to SE_03. On the other hand, in a case in which the light-shielding layer BM is formed of a metal material, it is preferable to have a configuration in which the light-shielding layer BM is provided in a layer different from the drive electrodes SE_01 to SE_03 with an insulating layer IL01 interposed therebetween.

As described in the first embodiment, since the light shielding element 104 is an element that blocks light, it is possible to block light even if the light-shielding layer BM does not exist in the regions between the drive electrodes SE_01 to SE_03. However, by providing the light-shielding layer BM between the drive electrodes SE_01 to SE_03, it is possible to block light passing through the inter-electrode regions, and it is possible to suppress a temperature rise of the second polarizing plate 1046. Thereby, it is possible to suppress degradation of the second polarizing plate 1046. Furthermore, by using the light-shielding layer BM, it is possible to obtain an effect equivalent to a case in which a second brightness enhancement film is provided. Since it is possible to build the light-shielding layer BM inside the liquid crystal panel 1044, it is possible to achieve a reduction in the thickness of the light shielding element 104 compared to a case in which a brightness enhancement film is used.

It is possible to apply the configuration shown in the present embodiment to the light shielding element 104 described in the first to third embodiments. Furthermore, it is possible to configure the lighting device 100 by using the light shielding element 104 shown in the present embodiment.

### FIFTH EMBODIMENT

The present embodiment illustrates a mode in which the configuration of the drive electrodes differs from that of the light-shielding element 104 shown in the third embodiment.

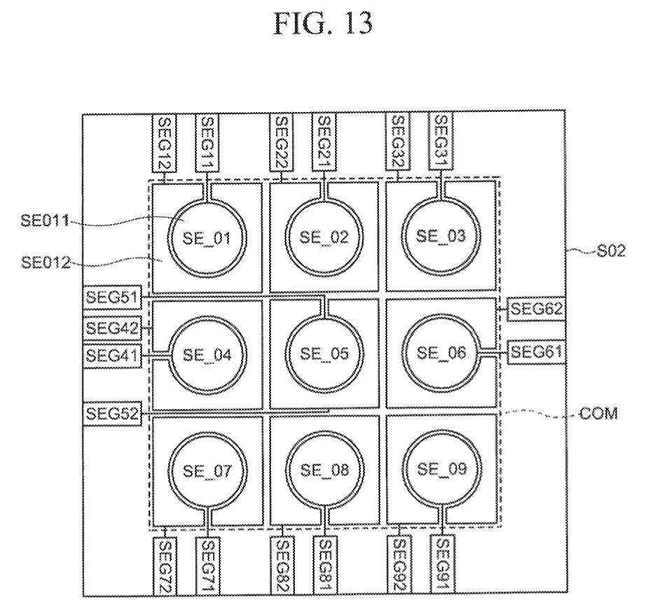

FIG. 13 illustrates a configuration of drive electrodes SE (SE_01 to SE_09) of the light shielding element 104 according to the present embodiment. FIG. 13 illustrates a configuration in which a plurality of drive electrodes SE_01 to SE_09 are arranged in a matrix. Each of the plurality of drive electrodes SE_01 to SE_09 has a configuration in which it is composed of a combination of a plurality of sub-electrodes.

Focusing on the drive electrode SE_01, the drive electrode SE_01 has a configuration in which it is composed of a first sub-drive electrode SE011 and a second sub-drive electrode SE012. The second sub-drive electrode SE012 has a configuration in which it is provided so as to surround the first sub-drive electrode SE011. Furthermore, while the first sub-drive electrode SE011 is circular in a plan view, the second sub-drive electrode SE012 has a configuration in which it has a quadrangular (rectangular) shape surrounding the circular electrode.

The first sub-drive electrode SE011 and the second sub-drive electrode SE012 are electrically separated, and it is possible to individually apply drive voltages to the respective sub-drive electrodes. Accordingly, the device has a configuration in which the first sub-drive electrode SE011 is connected to an input terminal SEG11, and the second sub-drive electrode SE012 is connected to an input terminal SEG12.

Regarding the other drive electrodes SE_02 to SE_09, it is possible to adopt a configuration in which the sub-drive electrodes and the input terminals are provided in a similar manner.

According to the configuration shown in FIG. 13 in which the drive electrodes SE (SE_01 to SE_09) are provided, it is possible to switch the irradiation shape of the spotlight not only to a circular shape but also to a quadrangular (rectangular) shape within the same irradiation area. Furthermore, it is possible to switch the area of the irradiation region of the spotlight between a large size and a small size.

Note that although FIG. 13 illustrates a case in which the first sub-drive electrode SE011 is circular and the second sub-drive electrode SE012 is quadrangular (rectangular), the configuration of the drive electrodes SE (SE_01 to SE_02) according to the present embodiment is not limited to such a combination. It is possible to combine various shapes for the first sub-drive electrode SE011 and the second sub-drive electrode SE012. For example, it is possible to make the shape of the first sub-drive electrode SE011 in a plan view triangular and the shape of the second sub-drive electrode SE012 in a plan view hexagonal.

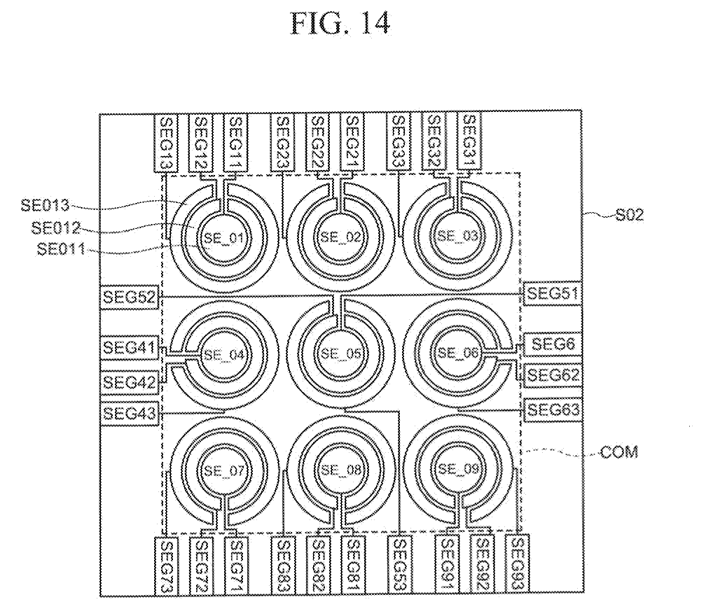

FIG. 14 illustrates another example of the drive electrodes SE (SE_01 to SE_02) according to the present embodiment. FIG. 14 illustrates a configuration in which a plurality of drive electrodes SE_01 to SE_09 are arranged in a matrix. The plurality of drive electrodes SE_01 to SE_09 have a configuration in which each of them is composed of a plurality of sub-electrodes arranged concentrically.

Focusing on the drive electrode SE_01, the drive electrode SE_01 has a configuration in which it is composed of a first sub-drive electrode SE011, a second sub-drive electrode SE012, and a third sub-drive electrode SE013. The drive electrode SE_01 has a configuration in which the first sub-drive electrode SE011 is arranged at the center, and the second sub-drive electrode SE012 and the third sub-drive electrode SE013 are arranged concentrically on the outer periphery thereof.

The first sub-drive electrode SE011, the second sub-drive electrode SE012, and the third sub-drive electrode SE013 are electrically separated, and it is possible to individually apply drive voltages to the respective sub-drive electrodes. The device has a configuration in which the first sub-drive electrode SE011 is connected to an input terminal SEG11, the second sub-drive electrode SE012 is connected to an input terminal SEG12, and the third sub-drive electrode SE013 is connected to an input terminal SEG13.

Regarding the other drive electrodes SE_02 to SE_09, it is possible to adopt a configuration in which the sub-drive electrodes and the input terminals are provided in a similar manner.

According to the configuration shown in FIG. 14 in which the drive electrodes SE (SE_01 to SE_09) are provided, it is possible to expand or shrink an irradiation range of the spotlight stepwise. Furthermore, in a case in which a state is achieved where drive voltages are applied to the first sub-drive electrode SE011 and the third sub-drive electrode SE013 and no drive voltage is applied to the second sub-drive electrode SE012, it is possible to add shading to brightness in an irradiation region of the spotlight.

Note that although FIG. 14 illustrates a case in which the sub-drive electrodes SE (SE_01 to SE_09) are circular, the configuration of the drive electrodes SE (SE_01 to SE_02) according to the present embodiment is not limited to such a shape. For example, it is possible to make the shape of the sub-drive electrodes SE (SE_01 to SE_09) in a plan view into various shapes such as a triangle, a quadrangle, a hexagon, or an ellipse.

As described above, according to the present embodiment, it is possible to give changes to the irradiation range and the irradiation shape of the spotlight by dividing each drive electrode into a configuration in which it is composed of sub-drive electrodes. Note that while FIG. 13 and FIG. 14 illustrate the plurality of drive electrodes SE_01 to SE_09, the number of drive electrodes is not limited to the illustrated examples, and it is possible to set the number appropriately.

It is possible to apply the configuration shown in the present embodiment to the light shielding element 104 described in the first to fourth embodiments. Furthermore, it is possible to configure the lighting device 100 by using the light shielding element 104 shown in the present embodiment.

### SIXTH EMBODIMENT

The present embodiment illustrates a mode in which the light-shielding element 104 is composed of a plurality of liquid crystal panels. Although the configuration of the liquid crystal panel in the present embodiment is substantially the same as that shown in the first embodiment, there is a difference in the arrangement of the drive electrodes. Hereinafter, descriptions will be given focusing on different parts, and descriptions of common parts will be omitted.

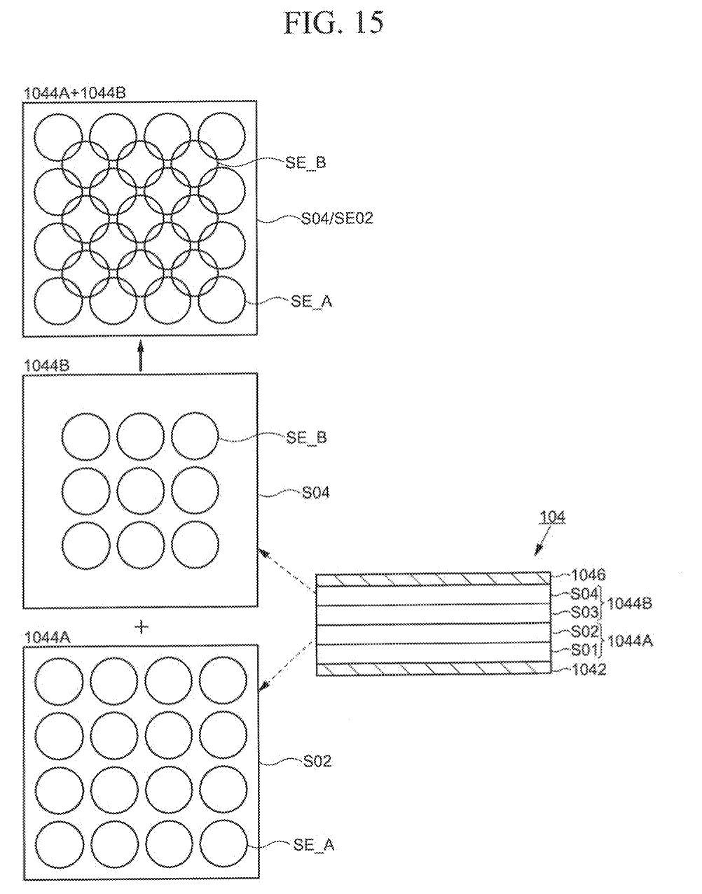

FIG. 15 illustrates a configuration of the light-shielding element 104 having a first liquid crystal panel 1044A and a second liquid crystal panel 1044B. The light-shielding element 104 has a configuration in which the first liquid crystal panel 1044A and the second liquid crystal panel 1044B are laminated between the first polarizing plate 1042 and the second polarizing plate 1046.

The first liquid crystal panel 1044A has a configuration in which it includes a first substrate S01, a second substrate S02, a liquid crystal layer LC01 (not shown) between the first substrate S01 and the second substrate S02, and a first alignment film (not shown) on a first substrate S01 side and a second alignment film (not shown) on a second substrate S02 side. The second liquid crystal panel 1044B has a configuration in which it includes a third substrate S03, a fourth substrate S04, a liquid crystal layer LC02 (not shown) between the third substrate S03 and the fourth substrate S04, and a third alignment film (not shown) on a third substrate S03 side and a fourth alignment film (not shown) on a fourth substrate S04 side.

FIG. 15 illustrates, as an inset, an arrangement of a first drive electrode SE_A provided on the second substrate S02 (or S02A) of the first liquid crystal panel 1044A and an arrangement of a second drive electrode SE_B provided on the second substrate S04 of the second liquid crystal panel 1044B. Note that a first common electrode COM (not shown) is provided so as to face the first drive electrode SE_A, and a second common electrode COM (not shown) is provided so as to face the second drive electrode SE_B. Although the first drive electrode SE_A and the second drive electrode SE_B are arranged in a matrix, the second drive electrode SE_B has a configuration in which it is arranged so as to overlap gaps (inter-electrode regions) of the first drive electrode SE_A. According to such a configuration, when the first liquid crystal panel 1044A and the second liquid crystal panel 1044B are laminated, it is possible to increase the density of the drive electrodes SE. By applying the light-shielding element 104 having such a configuration to the lighting device 100, it is possible to increase the degree of freedom of an irradiation position of the spotlight and a position for moving the spotlight. Furthermore, it is possible to widen the irradiation range of the spotlight by driving adjacent drive electrodes SE simultaneously in a transmission mode.

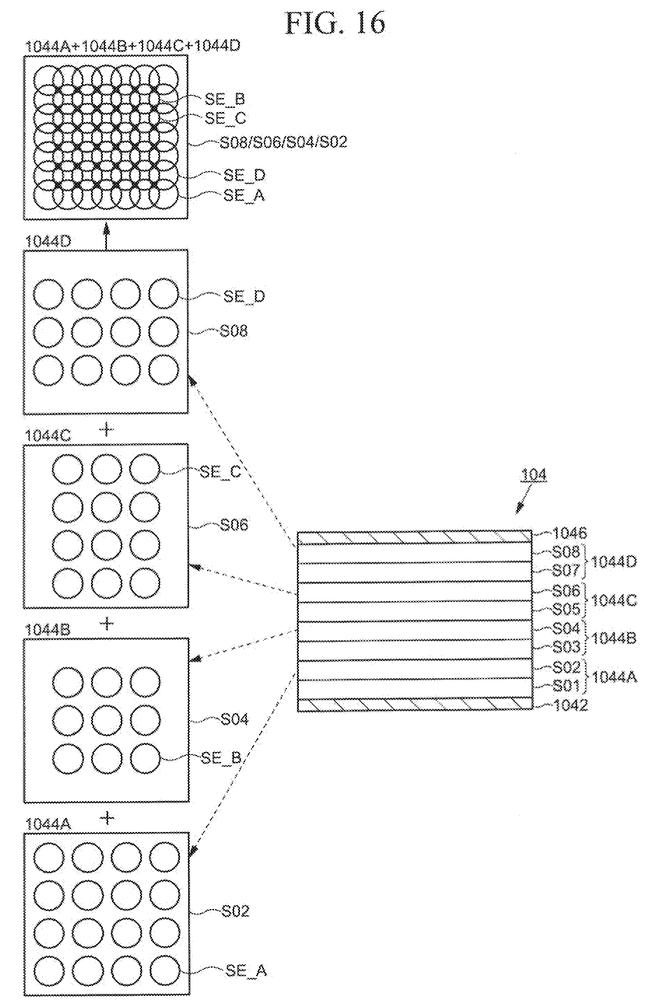

Note that the liquid crystal panels constituting the light-shielding element 104 are not limited to a two-stage configuration. For example, as shown in FIG. 16, it is possible to laminate four liquid crystal panels 1044A, 1044B, 1044C, and 1044D. In this case as well, by adopting a configuration in which the drive electrodes SE_A, SE_B, SE_C, and SE_D of the respective liquid crystal panels are arranged so as to fill the gaps (inter-electrode regions), it is possible to further increase the density of the drive electrodes, and it is possible to further increase the degree of freedom of an irradiation position of the spotlight and a position for moving the spotlight.

It is possible to apply the configuration shown in the present embodiment to the light shielding element 104 described in the first to fifth embodiments. Furthermore, it is possible to configure the lighting device 100 by using the light shielding element 104 shown in the present embodiment.

### SEVENTH EMBODIMENT

The present embodiment illustrates a mode in which the configuration of the light-shielding element 104 applied to the lighting device 100 differs from that in the first embodiment. In the present embodiment, the liquid crystal panel constituting the light-shielding element 104 has a configuration in which each drive electrode is driven by a transistor.

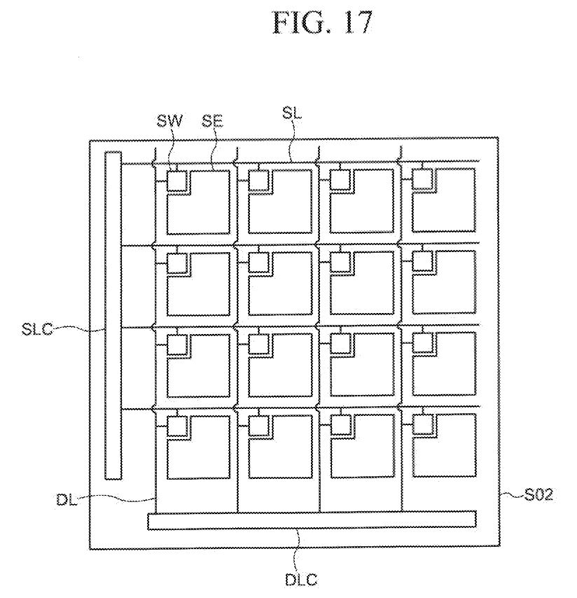

FIG. 17 illustrates a configuration on a substrate S02 side of a liquid crystal panel 1044 constituting a light-shielding element 104. The substrate S02 has a configuration in which drive electrodes SE arranged in a matrix and switching elements SW arranged corresponding to the respective drive electrodes SE are provided. It is possible to form the switching element SW (or SE as in the original text) using, for example, a thin-film transistor (TFT). Furthermore, scanning signal lines SL and data signal lines DL are provided on the substrate S02. The scanning signal line SL is connected to a scanning signal line driver circuit SLC, and the data signal line DL is connected to a selector circuit DLC. A signal for selecting the switching element SW to which data is to be written is input to the scanning signal line SL, and a drive signal for driving the drive electrode SE is input to the data signal line DL.

It is possible to set each size of the drive electrodes SE arranged in a matrix (the length of one side for a rectangle, the length of a diagonal for a polygon, or the diameter for a circle) to several tens of micrometers to several hundreds of micrometers. For example, it is possible to make the shape of the drive electrode SE rectangular and to set the length of one side to 20 µm to 400 µm. Furthermore, the shape of the plurality of drive electrodes SE in a plan view is not limited to a rectangle, and it is possible to use other shapes such as a triangle, a hexagon, a circle, or an ellipse.

The liquid crystal panel 1044 constituting the light-shielding element 104 shown in the first embodiment has a configuration in which a drive voltage is applied to each drive electrode SE. On the other hand, since the liquid crystal panel 1044 according to the present embodiment is driven by active-matrix driving, it is possible to drive the ON and OFF states of the drive electrodes SE at a higher speed, and it is possible to move an irradiation position of the spotlight more smoothly. Furthermore, it is possible to make an irradiation shape (spot shape) of the spotlight into various shapes such as a circle, a quadrangle, a rectangle, a triangle, or a star shape.

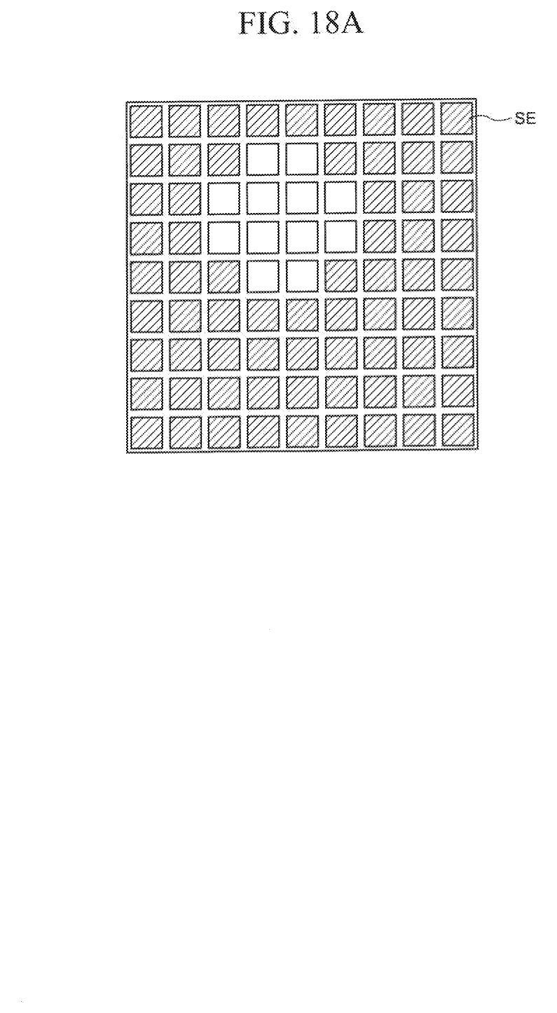

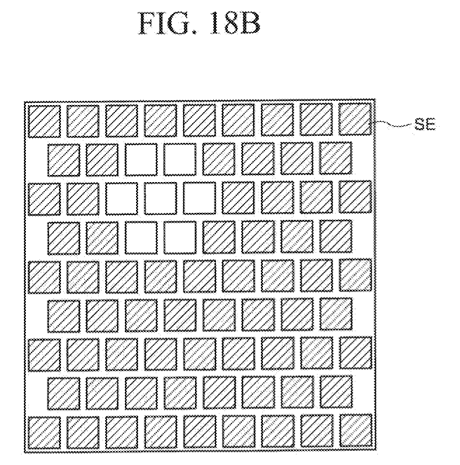

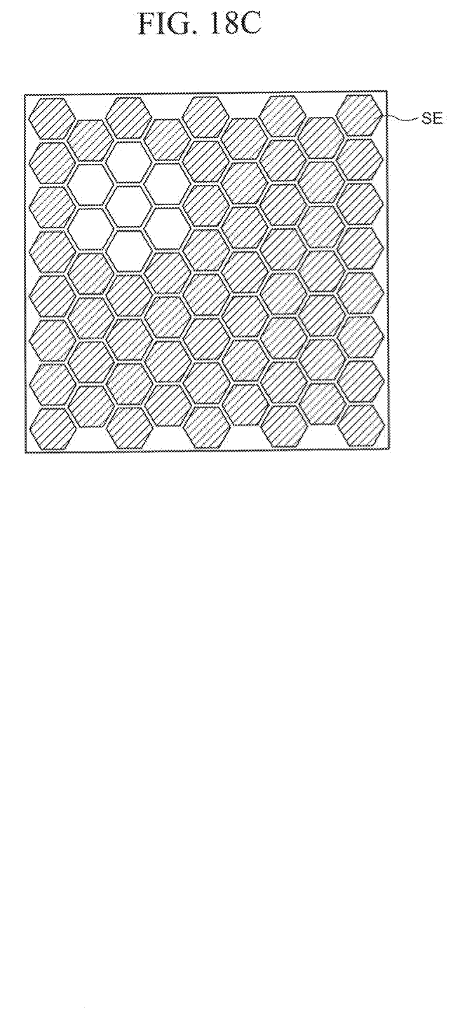

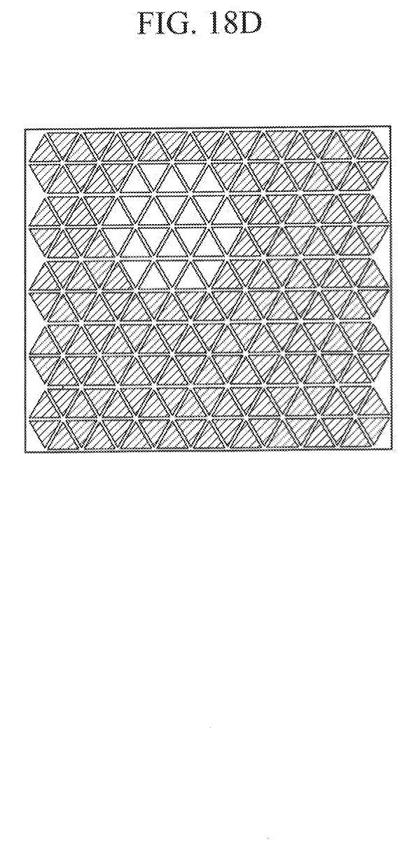

FIG. 18A illustrates an example in which the drive electrodes SE are arranged in a matrix in a row direction and a column direction. FIG. 18A illustrates the drive electrodes SE in an ON state (transmission mode) as open shapes and illustrates the drive electrodes SE in an OFF state (light-shielding mode) with hatching. As shown in FIG. 18A, by selecting a plurality of adjacent drive electrodes SE to be in the ON state (transmission mode), it is possible to freely change the size and an irradiation shape (spot shape) of an irradiation area of the spotlight.

FIG. 18B illustrates an example in which the drive electrodes SE are arranged in a delta arrangement. With the configuration shown in FIG. 18B, it is possible to freely form the size and the irradiation shape (spot shape) of the irradiation area of the spotlight as well. FIG. 18C illustrates an example in which the shape of the drive electrodes SE in a plan view is hexagonal and they are arranged in a dense packing arrangement. According to the arrangement of the drive electrodes SE shown in FIG. 18C, it is possible to make the contour of the spot shape of the irradiated spotlight smoother in a case in which a plurality of the drive electrodes SE are set to the ON state to make a predetermined range the transmission mode. FIG. 18D illustrates an example in which the hexagonal drive electrode SE is further divided into six sub-segments. According to the configuration of the drive electrodes SE shown in FIG. 18D, it is possible to form a high-definition spot shape.

Since the liquid crystal panel 1044 of the present embodiment adopts a configuration in which the drive electrodes SE can be active-matrix driven using the switching elements SE (or SW), it is possible to increase the definition of the drive electrodes SE without significantly increasing the number of wires. Consequently, it is possible to move the spotlight smoothly and form its irradiation shape with smooth curves.

It is possible to apply the configuration shown in the present embodiment to the light shielding element 104 described in the first embodiment and the second embodiment. Furthermore, it is possible to configure the lighting device 100 by using the light shielding element 104 shown in the present embodiment.

What is claimed is:

1. A lighting device, comprising:
a light source configured to illuminate a target space;
a light shielding element disposed on an optical path of light emitted from the light source,
wherein the light shielding element comprises:
a first liquid crystal panel including a first substrate, a second substrate facing the first substrate, and a first liquid crystal layer disposed between the first substrate and the second substrate;
a first polarizing plate and a second polarizing plate sandwiching the first liquid crystal panel and arranged in a crossed-Nicols configuration or a parallel-Nicol configuration;
wherein the first liquid crystal panel includes a first common electrode and a plurality of first drive electrodes; and
wherein each of the plurality of first drive electrodes is independently controlled to be in a light-shielding mode that blocks light from the light source or a transmission mode that transmits light from the light source.

2. The lighting device according to claim 1, wherein the light shielding element forms a light-shielding region by controlling the plurality of first drive electrodes to the light-shielding mode, and forms a transmission region within the light-shielding region by controlling at least one of the plurality of first drive electrodes to the transmission mode.

3. The lighting device according to claim 1, further comprising a second liquid crystal panel including a third substrate, a fourth substrate facing the third substrate, and a second liquid crystal layer disposed between the third substrate and the fourth substrate,
wherein the second liquid crystal panel includes a second common electrode and a plurality of second drive electrodes;
wherein the first liquid crystal panel and the second liquid crystal panel are stacked between the first polarizing plate and the second polarizing plate;
wherein the plurality of second drive electrodes is arranged to overlap regions between the plurality of first electrodes; and
wherein the light shielding element is configured such that each of the plurality of first drive electrodes and each of the plurality of second drive electrodes independently controls a corresponding region to switch between a light-shielding mode that blocks light from the light source and a transmission mode that transmits light from the light source.

4. The lighting device according to claim 3, wherein
the light shielding element forms a first light-shielding region by controlling the plurality of first drive electrodes to the light-shielding mode, and forms a first transmission region within the first light-shielding region by controlling at least one of the plurality of first drive electrodes to the transmission mode; and
the light shielding element forms a second light-shielding region by controlling the plurality of second drive electrodes to the light-shielding mode, and forms a second transmission region adjacent to the first transmission region within the second light-shielding region by controlling at least one of the plurality of second drive electrodes to the transmission mode.

5. The lighting device according to claim 1, wherein the light shielding element has a plurality of first drive electrodes arranged in a matrix, and has transistors each connected to a corresponding one of the plurality of first drive electrodes.

6. The lighting device according to claim 5, wherein each of the plurality of first drive electrodes independently controls a corresponding region to switch between the light-shielding mode and the transmission mode, and
wherein the light shielding element is configured to be capable of expanding and reducing a range, among the plurality of first drive electrodes, that is controlled to the transmission mode.

7. The lighting device according to claim 1, further comprising:
a first brightness enhancement film disposed on a surface of the first polarizing plate opposite to the first substrate; and
a second brightness enhancement film disposed between the second substrate and the second polarizing plate.

8. The lighting device according to claim 1, wherein each of the plurality of first drive electrodes is divided into a plurality of regions.

9. The lighting device according to claim 1, wherein a liquid crystal material of the first liquid crystal layer is a twisted nematic liquid crystal.

10. The lighting device according to claim 1, further comprising a liquid crystal light control element including a pair of substrates disposed oppositely and a liquid crystal layer disposed between the pair of substrates, the liquid crystal light control element being configured to control a diffusion direction of light emitted from the light source,
wherein the liquid crystal light control element is stacked with the light shielding element.
